(19) United States
(12) Patent Application Publication
(10) Pub. No.: US 2025/0127235 A1
(43) Pub. Date: Apr. 24, 2025

(54) APPARATUS AND METHODS FOR LIQUID SENSING IN REFILLABLE ARTICLES FOR ELECTRONIC AEROSOL PROVISION SYSTEMS

(71) Applicant: NICOVENTURES TRADING LIMITED, London (GB)

(72) Inventors: Stephen JACKSON, London (GB); Hadyn VAN DER BERG, London (GB); Mohammed AL-AMIN, London (GB)

(21) Appl. No.: 18/688,900

(22) PCT Filed: Aug. 26, 2022
(86) PCT No.: PCT/GB2022/052199

§ 371 Date: Mar. 4, 2024

(30) Foreign Application Priority Data
Sep. 3, 2021 (GB) 2112584.4
Nov. 26, 2021 (GB) 2117097.2

(51) Int. Cl. A24F 40/51; A24F 40/10; A24F 40/42; A24F 40/46; A24F 40/53; B67D 7/02; G01F 23/263

(52) U.S. Cl. CPC A24F 40/51; A24F 40/10; A24F 40/42; A24F 40/46; A24F 40/53; B67D 7/0288; G01F 23/263

(57) ABSTRACT

An article and related apparatus and methods for an aerosol provision system, including: a storage area for aerosol-generating material; an inlet orifice in fluid communication with an interior of the storage area by which aerosol-generating material can be added into the storage area; a first capacitive sensor including a first pair of capacitor plates arranged to measure a capacitance of the storage area; a second capacitive sensor including a second pair of capacitor plates arranged to measure a capacitance of the storage area; and electrical contacts by which capacitance measurements made by the first capacitive sensor and the second capacitive sensor can be separately ascertained externally to the article.

### RELATED APPLICATIONS

The present application is a National Phase entry of PCT Application PCT/GB2022/052199 filed Aug. 26, 2022, which claims priority to GB Application No. 2112584.4 filed Sep. 3, 2021 and GB Application No. 2117097.2 filed Nov. 26, 2021, each of which is hereby incorporated by reference in their entirety.

### TECHNICAL FIELD

The present disclosure relates to apparatus and methods for liquid sensing in refillable articles for electronic aerosol provision systems.

### BACKGROUND

Electronic aerosol provision systems, which are often configured as so-called electronic cigarettes, can have a unitary format with all elements of the system in a common housing, or a multi-component format in which elements are distributed between two or more housings which can be coupled together to form the system. A common example of the latter format is a two-component system comprising a device and an article. The device typically contains an electrical power source for the system, such as a battery, and control electronics for operating elements in order to generate aerosol. The article, also referred to by terms including cartridge, cartomiser, consumable and clearomiser, typically contains a storage volume or area for holding a supply of aerosolizable/aerosol-generating material from which the aerosol is generated, plus an aerosol generator such as a heater operable to vaporize the aerosolizable material. A similar three-component system may include a separate mouthpiece that attaches to the article. In many designs, the article is designed to be disposable, in that it is intended to be detached from the device and thrown away when the aerosolizable material has been consumed. The user obtains a new article which has been prefilled with aerosolizable material by a manufacturer and attaches it to the device for use. The device, in contrast, is intended to be used with multiple consecutive articles, with a capability to recharge the battery to allow prolonged operation.

While disposable articles, which may be called consumables, are convenient for the user, they may be considered wasteful of natural resources and hence detrimental to the environment. An alternative design of article is therefore known, which is configured to be refilled with aerosolizable material by the user. This reduces waste, and can reduce the cost of electronic cigarette usage for the user. The aerosolizable material may be provided in a bottle, for example, from which the user squeezes or drips a quantity of material into the article via a refilling orifice on the article. However, the act of refilling can be awkward and inconvenient, since the items are small and the volume of material involved is typically low. Alignment of the juncture between bottle and article can be difficult, with inaccuracies leading to spillage of the material. This is not only wasteful, but may also be dangerous. Aerosolizable material frequently contains liquid nicotine, which can be poisonous if it makes contact with the skin.

Therefore, refilling units or devices have been proposed, which are configured to receive a bottle or other reservoir of aerosolizable material plus a refillable cartridge, and to automate the transfer of the material from the former to the latter. Alternative, improved or enhanced features and designs for such refilling devices are therefore of interest.

### SUMMARY

According to a first aspect of some embodiments described herein, there is provided an article for an aerosol provision system, comprising: a storage area for aerosol-generating material; an inlet orifice in fluid communication with an interior of the storage area by which aerosol-generating material can be added into the storage area; a first capacitive sensor comprising a first pair of capacitor plates arranged to measure a capacitance of the storage area; a second capacitive sensor comprising a second pair of capacitor plates arranged to measure a capacitance of the storage area; and electrical contacts by which capacitance measurements made by the first capacitive sensor and the second capacitive sensor can be separately ascertained externally to the article.

According to a second aspect of some embodiments described herein, there is provided an aerosol provision system comprising an article according to the first aspect.

According to a third aspect of some embodiments described herein, there is provided a refilling device for refilling an article from a reservoir, comprising: a reservoir interface for receiving a reservoir containing aerosol-generating material and having an outlet orifice; an article interface for receiving an article of an aerosol provision system having a storage area for aerosol-generating material, such that a fluid flow path is formed between the outlet orifice of the reservoir and the storage area of the article, the article according to any one of claims 1 to 8; a transfer mechanism operable to move aerosol generating material from a received reservoir to the storage area of a received article; and a controller configured to operate the transfer mechanism, and also to: retrieve first capacitance measurements made by the first capacitive sensor and second capacitance measurements made by the second capacitive sensor while the transfer mechanism is operating; process the first capacitance measurements and the second capacitance measurements to determine when the storage area of the article contains aerosol generating material to a predetermined capacity of the storage area; and in response, cease operation of the transfer mechanism.

According to a fourth aspect of some embodiments described herein, there is provided apparatus for refilling an article of an aerosol provision system, the apparatus comprising an aerosol provision system comprising an article according to the first aspect, and a refilling device according to the third aspect.

According to a fifth aspect of some embodiments described herein, there is provided a method of refilling an article from a reservoir, comprising: obtaining first capacitance measurements of a storage area of the article from a first capacitive sensor and second capacitance measurements of the storage area of the article from a second capacitive sensor while aerosol-generating material is moved from the reservoir into the storage area; processing the first capacitance measurements and the second capacitance measurements to determine when the storage area contains aerosol generating material to a predetermined capacity of the storage area; and ceasing movement of the aerosol-generating material into the storage area when the predetermined capacity is determined to be reached.

According to a sixth aspect of certain embodiments there is provided a refilling device for refilling an article with aerosol-generating material for use with an aerosol provision device, the refilling device including: a transfer mechanism configured to transfer aerosol-generating material to the article; aerosol-generating material amount sensing circuitry configured to determine an amount of aerosol-generating material within the article when engaged with the refilling device; and a controller configured to: receive a reference value from the article, the reference value indicative of a characteristic of the article associated with the aerosol-generating material amount sensing circuitry; using at least the received reference value to modify a default mapping between the measured indication of a characteristic of an arbitrary article and an amount of aerosol-generating material in the arbitrary article; and control the refilling device to supply an amount of aerosol-generating material to the article based on the modified mapping.

According to a seventh aspect of certain embodiments there is provided an article for use with an aerosol provision device, configured to store aerosol-generating material and to be refilled with aerosol-generating material by a refilling device, the refilling device comprising a transfer mechanism configured to transfer aerosol-generating material to the article and aerosol-generating material amount sensing circuitry configured to determine an amount of aerosol-generating material within the article when engaged with the refilling device, the article including: a reference value, the reference value indicative of a characteristic of the article associated with the aerosol-generating material amount sensing circuitry, wherein the refilling mechanism is configured to receive the reference value from the article, and using at least the received reference value, modify a default mapping between the measured indication of a characteristic of an arbitrary article and an amount of aerosol-generating material in the arbitrary article, and control the refilling mechanism to supply an amount of aerosol-generating material to the article based on the modified mapping.

According to an eighth aspect of certain embodiments there is provided a system for refilling an article with aerosol-generating material, the system comprising the refilling device of the sixth aspect and the article of the seventh aspect.

According to a ninth aspect of certain embodiments there is provided a method for operating a refilling device for refilling an article with aerosol-generating material for use with an aerosol provision device, the refilling device comprising a transfer mechanism configured to transfer aerosol-generating material to the article and aerosol-generating material amount sensing circuitry configured to determine an amount of aerosol-generating material within the article when engaged with the refilling device, the method including: receiving a reference value from the article, the reference value indicative of a characteristic of the article associated with the aerosol-generating material amount sensing circuitry; using at least the received reference value to modify a default mapping between the measured indication of a characteristic of an arbitrary article and an amount of aerosol-generating material in the arbitrary article; and controlling the refilling device to supply an amount of aerosol-generating material to the article based on the modified mapping.

According to a tenth aspect of certain embodiments there is provided a refilling means for refilling an article with aerosol-generating material for use with aerosol provision means, the refilling means comprising: transfer means configured to transfer aerosol-generating material to the article; aerosol-generating material amount sensing means configured to determine an amount of aerosol-generating material within the article when engaged with the refilling means; and controller means configured to: receive a reference value from the article, the reference value indicative of a characteristic of the article associated with the aerosol-generating material amount sensing means; using at least the received reference value to modify a default mapping between the measured indication of a characteristic of an arbitrary article and an amount of aerosol-generating material in the arbitrary article; and control the refilling means to supply an amount of aerosol-generating material to the article based on the modified mapping.

According to an eleventh aspect of certain embodiments there is provided an article for use with aerosol provision means, configured to store aerosol-generating material and to be refilled with aerosol-generating material by refilling means, the refilling means comprising transfer means configured to transfer aerosol-generating material to the article and aerosol-generating material amount sensing means configured to determine an amount of aerosol-generating material within the article when engaged with the refilling means, the article comprising: a reference value, the reference value indicative of a characteristic of the article associated with the aerosol-generating material amount sensing means, wherein the refilling means is configured to receive the reference value from the article, and using at least the received reference value, modify a default mapping between the measured indication of a characteristic of an arbitrary article and an amount of aerosol-generating material in the arbitrary article, and control the refilling means to supply an amount of aerosol-generating material to the article based on the modified mapping.

These and further aspects of the certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, apparatus and methods for liquid sensing in refillable articles for electronic aerosol provision systems may be provided in accordance with approaches described herein which includes any one or more of the various features described below as appropriate.

### BRIEF DESCRIPTION OF THE DRAWINGS

Various embodiments of the invention will now be described in detail by way of example only with reference to the following drawings in which:

FIG. 1 shows a simplified schematic cross-section through an example electronic aerosol provision system in which embodiments of the present disclosure can be implemented;

FIG. 2 shows a simplified schematic representation of a refilling device to which embodiments of the present disclosure area applicable;

FIG. 3 shows a simplified schematic cross-sectional view of a reservoir refilling an article of an aerosol provision system according to an example of the disclosure;

FIG. 4 shows a simplified schematic longitudinal cross-sectional view of a first example article according to the present disclosure;

FIG. 5 shows a simplified schematic representation of first and second capacitive sensors according to an example of the present disclosure;

FIG. 6 shows a flow chart of steps in an example method of controlling article refilling using capacitance measurements according to an example of the present disclosure;

FIG. 7 shows a graph of measured capacitance with fluid level in an article using two example capacitive sensors according to the present disclosure;

FIGS. 8A-8E show respectively, experimental measurements and calculations over a 24 hour observation period for an article with a storage area filled with aerosol generating material of temperature (FIG. 8A), first capacitance from a first sensor (FIG. 8B), second capacitance from a second sensor (FIG. 8C), first capacitance corrected using the second capacitance (FIG. 8D), and error in the corrected first capacitance (FIG. 8E);

FIG. 9 shows a simplified schematic cross-section through an example electronic aerosol provision system in which embodiments of the present disclosure can be implemented;

FIG. 10 shows a simplified schematic representation of a refilling device to which embodiments of the present disclosure are applicable;

FIG. 11 shows a simplified schematic cross-sectional view of a reservoir refilling an article of an aerosol provision system according to an example of the disclosure;

FIG. 12 shows a simplified schematic representation of part of the refilling device of FIG. 10 in more detail exemplifying the aerosol-generating material amount sensing circuitry in accordance with an aspect of the present disclosure;

FIG. 13 shows a graph highlighting the relationship between a capacitance obtained by placing the article between two parallel capacitor plates and the amount of aerosol-generating material within the article;

FIG. 14 shows a graph highlighting two plots of capacitance obtained by placing an article between two parallel capacitor plates and the amount of aerosol-generating material within the article as compared to a default relationship between capacitance and an amount of aerosol-generating material in a default article;

FIG. 15 shows a graph highlighting two plots of capacitance obtained by placing an article between two parallel capacitor plates and the amount of aerosol-generating material within the article where the two plots show different relationships; and

FIG. 16 shows a flow diagram indicating a method for operating the refilling mechanism in accordance with aspects of the present disclosure; and

FIGS. 17a and 17b show modifications to the method of FIG. 16 in accordance with aspects of the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates to (but is not limited to) electronic aerosol or vapor provision systems, such as e-cigarettes. Throughout the following description the terms “e-cigarette” and “electronic cigarette” may sometimes be used; however, it will be appreciated these terms may be used interchangeably with aerosol (vapor) provision system or device. The systems are intended to generate an inhalable aerosol by vaporization of a substrate (aerosol-generating material) in the form of a liquid or gel which may or may not contain nicotine. Additionally, hybrid systems may comprise a liquid or gel substrate plus a solid substrate which is also heated. The solid substrate may be for example tobacco or other non-tobacco products, which may or may not contain nicotine. The terms “aerosol-generating material” and “aerosolizable material” as used herein are intended to refer to materials which can form an aerosol, either through the application of heat or some other means. The term “aerosol” may be used interchangeably with “vapor”.

As used herein, the terms “system” and “delivery system” are intended to encompass systems that deliver a substance to a user, and include non-combustible aerosol provision systems that release compounds from an aerosolizable material without combusting the aerosolizable material, such as electronic cigarettes, tobacco heating products, and hybrid systems to generate aerosol using a combination of aerosolizable materials, and articles comprising aerosolizable material and configured to be used within one of these non-combustible aerosol provision systems. According to the present disclosure, a “non-combustible” aerosol provision system is one where a constituent aerosol generating material of the aerosol provision system (or component thereof) is not combusted or burned in order to facilitate delivery to a user. In some embodiments, the delivery system is a non-combustible aerosol provision system, such as a powered non-combustible aerosol provision system. In some embodiments, the non-combustible aerosol provision system is an electronic cigarette, also known as a vaping device or electronic nicotine delivery (END) system, although it is noted that the presence of nicotine in the aerosol generating material is not a requirement. In some embodiments, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the non-combustible aerosol provision system may comprise a non-combustible aerosol provision device and an article (consumable) for use with the non-combustible aerosol provision device. However, it is envisaged that articles which themselves comprise a means for powering an aerosol generator or aerosol generating component may themselves form the non-combustible aerosol provision system. In some embodiments, the non-combustible aerosol provision device may comprise a power source and a controller. The power source may, for example, be an electric power source. In some embodiments, the article for use with the non-combustible aerosol provision device may comprise an aerosol generating material, an aerosol generating component (aerosol generator), an aerosol generating area, a mouthpiece, and/or an area for receiving and holding aerosol generating material.

In some systems the aerosol generating component or aerosol generator comprises a heater capable of interacting with the aerosolizable material so as to release one or more volatiles from the aerosolizable material to form an aerosol. However, the disclosure is not limited in this regard, and applies also to systems that use other approaches to form aerosol, such as a vibrating mesh.

In some embodiments, the article for use with the non-combustible aerosol provision device may comprise aerosolizable material or an area for receiving aerosolizable material. In some embodiments, the article for use with the non-combustible aerosol provision device may comprise a mouthpiece. The area for receiving aerosolizable material may be a storage area for storing aerosolizable material. For example, the storage area may be a reservoir. In some embodiments, the area for receiving aerosolizable material may be separate from, or combined with, an aerosol generating area.

As used herein, the term “component” may be used to refer to a part, section, unit, module, assembly or similar of an electronic cigarette or similar device that incorporates several smaller parts or elements, possibly within an exterior housing or wall. An aerosol provision system such as an electronic cigarette may be formed or built from one or more such components, such as an article and a device, and the components may be removably or separably connectable to one another, or may be permanently joined together during manufacture to define the whole system. The present disclosure is applicable to (but not limited to) systems comprising two components separably connectable to one another and configured, for example, as an article in the form of an aerosolizable material carrying component holding liquid or another aerosolizable material (alternatively referred to as a cartridge, cartomiser, pod or consumable), and a device having a battery or other power source for providing electrical power to operate an aerosol generating component or aerosol generator for creating vapor/aerosol from the aerosolizable material. A component may include more or fewer parts than those included in the examples.

In some examples, the present disclosure relates to aerosol provision systems and components thereof that utilize aerosolizable material in the form of a liquid or a gel which is held in a storage area such as a reservoir, tank, container or other receptacle comprised in the system, or absorbed onto a carrier substrate. An arrangement for delivering the material from the reservoir for the purpose of providing it to an aerosol generator for vapor/aerosol generation is included. The terms “liquid”, “gel”, “fluid”, “source liquid”, “source gel”, “source fluid” and the like may be used interchangeably with terms such as “aerosol-generating material”, “aerosolizable substrate material” and “substrate material” to refer to material that has a form capable of being stored and delivered in accordance with examples of the present disclosure.

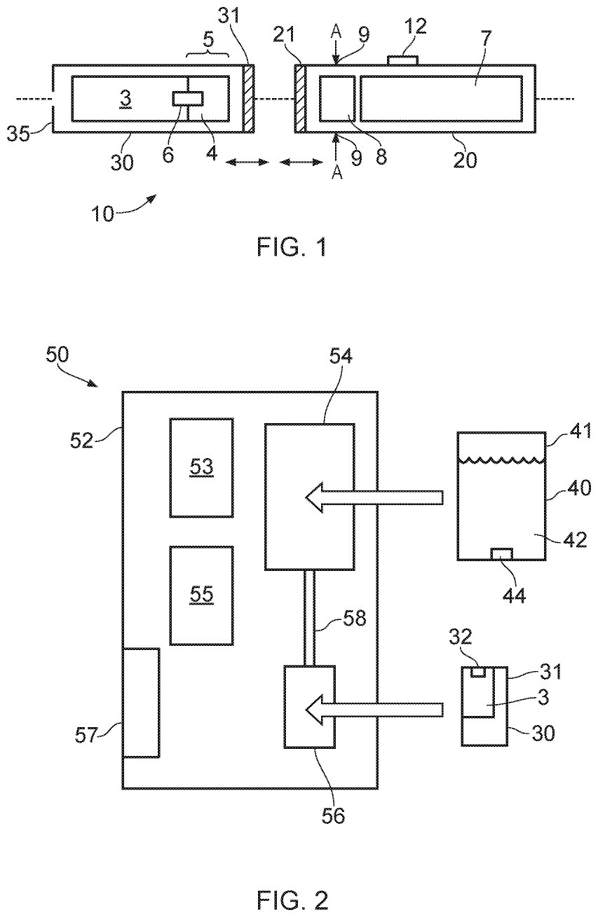

FIG. 1 is a highly schematic diagram (not to scale) of a generic example electronic aerosol/vapor provision system such as an e-cigarette 10, presented for the purpose of showing the relationship between the various parts of a typical system and explaining the general principles of operation. Note that the present disclosure is not limited to a system configured in this way, and features may be modified in accordance with the various alternatives and definitions described above and/or apparent to the skilled person. The e-cigarette 10 has a generally elongate shape in this example, extending along a longitudinal axis indicated by a dashed line, and comprises two main components, namely a device 20 (control or power component, section or unit), and an article or consumable 30 (cartridge assembly or section, sometimes referred to as a cartomiser, clearomiser or pod) carrying aerosol-generating material and operating to generate vapor/aerosol.

The article 30 includes a storage area such as a reservoir 3 for containing a source liquid or other aerosol-generating material comprising a formulation such as liquid or gel from which an aerosol is to be generated, for example containing nicotine. As an example, the source liquid may comprise around 1% to 3% nicotine and 50% glycerol, with the remainder comprising roughly equal measures of water and propylene glycol, and possibly also comprising other components, such as flavorings. Nicotine-free source liquid may also be used, such as to deliver flavoring. A solid substrate (not illustrated), such as a portion of tobacco or other flavor element through which vapor generated from the liquid is passed, may also be included. The reservoir 3 may have the form of a storage tank, being a container or receptacle in which source liquid can be stored such that the liquid is free to move and flow within the confines of the tank. In other examples, the storage area may comprise absorbent material (either inside a tank or similar, or positioned within the outer housing of the article) that holds the aerosol generating material. For a consumable article, the reservoir 3 may be sealed after filling during manufacture so as to be disposable after the source liquid is consumed. However, the present disclosure is relevant to refillable articles that have an inlet port, orifice or other opening (not shown in FIG. 1) through which new source liquid can be added to enable reuse of the article 30. The article 30 also comprises an aerosol generator 5, comprising in this example an aerosol generating component, which may have the form of an electrically powered heating element or heater 4 and an aerosol-generating material transfer component 6. The heater 4 is located externally of the reservoir 3 and is operable to generate the aerosol by vaporization of the source liquid by heating. The aerosol-generating material transfer component 6 is a transfer or delivery arrangement configured to deliver aerosol-generating material from the reservoir 3 to the heater 4. In some examples, it may have the form of a wick or other porous element. A wick 6 may have one or more parts located inside the reservoir 3, or otherwise be in fluid communication with liquid in the reservoir 3, so as to be able to absorb source liquid and transfer it by wicking or capillary action to other parts of the wick 6 that are adjacent or in contact with the heater 4. This liquid is thereby heated and vaporized, and replacement liquid drawn, via continuous capillary action, from the reservoir 3 for transfer to the heater 4 by the wick 6. The wick may be thought of as a conduit between the reservoir 3 and the heater 4 that delivers or transfers liquid from the reservoir to the heater. In some designs, the heater 4 and the aerosol-generating material transfer component 6 are unitary or monolithic, and formed from a same material that is able to be used for both liquid transfer and heating, such as a material which is both porous and conductive. In still other cases, the aerosol-generating material transfer component may operate other than by capillary action, such as by comprising an arrangement of one or more valves by which liquid may exit the reservoir 3 and be passed onto the heater 4.

A heater and wick (or similar) combination, referred to herein as an aerosol generator 5, may sometimes be termed an atomiser or atomiser assembly, and the reservoir with its source liquid plus the atomiser may be collectively referred to as an aerosol source. Various designs are possible, in which the parts may be differently arranged compared with the highly schematic representation of FIG. 1. For example, and as mentioned above, the wick 6 may be an entirely separate element from the heater 4, or the heater 4 may be configured to be porous and able to perform at least part of the wicking function directly (a metallic mesh, for example). In the present example, the system is an electronic system, and the heater 4 may comprise one or more electrical heating elements that operate by ohmic/resistive (Joule) heating, although inductive heating may also be used, in which case the heater comprises a susceptor in an induction heating arrangement. A heater of this type could be configured in line with the examples and embodiments described in more detail below. In general, therefore, an atomiser or aerosol generator, in the present context, can be considered as one or more elements that implement the functionality of a vapor-generating element able to generate vapor by heating source liquid (or other aerosol-generating material) delivered to it, and a liquid transport or delivery element able to deliver or transport liquid from a reservoir or similar liquid store to the vapor-generating element by a wicking action/capillary force or otherwise. An aerosol generator is typically housed in an article 30 of an aerosol generating system, as in FIG. 1, but in some examples, at least the heater part may be housed in the device 20. Embodiments of the disclosure are applicable to all and any such configurations which are consistent with the examples and description herein.

Returning to FIG. 1, the article 30 also includes a mouthpiece or mouthpiece portion 35 having an opening or air outlet through which a user may inhale the aerosol generated by the heater 4.

The device 20 includes a power source such as cell or battery 7 (referred to hereinafter as a battery, and which may or may not be re-chargeable) to provide electrical power for electrical components of the e-cigarette 10, in particular to operate the heater 4. Additionally, there is a controller 8 such as a printed circuit board and/or other electronics or circuitry for generally controlling the e-cigarette. The controller may include a processor programmed with software, which may be modifiable by a user of the system. The control electronics/circuitry 8 operates the heater 4 using power from the battery 7 when vapor is required. At this time, the user inhales on the system 10 via the mouthpiece 35, and air A enters through one or more air inlets 9 in the wall of the device 20 (air inlets may alternatively or additionally be located in the article 30). When the heater 4 is operated, it vaporizes source liquid delivered from the reservoir 3 by the aerosol-generating material transfer component 6 to generate the aerosol by entrainment of the vapor into the air flowing through the system, and this is then inhaled by the user through the opening in the mouthpiece 35. The aerosol is carried from the aerosol generator 5 to the mouthpiece 35 along one or more air channels (not shown) that connect the air inlets 9 to the aerosol generator 5 to the air outlet when a user inhales on the mouthpiece 35.

More generally, the controller 8 is suitably configured/programmed to control the operation of the aerosol provision system to provide functionality in accordance with embodiments and examples of the disclosure as described further herein, as well as for providing conventional operating functions of the aerosol provision system in line with established techniques for controlling such devices. The controller 8 may be considered to logically comprise various sub-units/circuitry elements associated with different aspects of the aerosol provision system's operation in accordance with the principles described herein and other conventional operating aspects of aerosol provision systems, such as display driving circuitry for systems that may include a user display (such as an screen or indicator) and user input detections via one or more user actuable controls 12. It will be appreciated that the functionality of the controller 8 can be provided in various different ways, for example using one or more suitably programmed programmable computers and/or one or more suitably configured application-specific integrated circuits/circuitry/chips/chipsets configured to provide the desired functionality.

The device 20 and the article 30 are separate connectable parts detachable from one another by separation in a direction parallel to the longitudinal axis, as indicated by the double-headed arrows in FIG. 1. The components 20, 30 are joined together when the system 10 is in use by cooperating engagement elements 21, 31 (for example, a screw or bayonet fitting) which provide mechanical and in some cases electrical connectivity between the device 20 and the article 30. Electrical connectivity is required if the heater 4 operates by ohmic heating, so that current can be passed through the heater 4 when it is connected to the battery 5. In systems that use inductive heating, electrical connectivity can be omitted if no parts requiring electrical power are located in the article 30. An inductive work coil can be housed in the device 20 and supplied with power from the battery 5, and the article 30 and the device 20 shaped so that when they are connected, there is an appropriate exposure of the heater 4 to flux generated by the coil for the purpose of generating current flow in the material of the heater. The FIG. 1 design is merely an example arrangement, and the various parts and features may be differently distributed between the device 20 and the article 30, and other components and elements may be included. The two sections may connect together end-to-end in a longitudinal configuration as in FIG. 1, or in a different configuration such as a parallel, side-by-side arrangement. The system may or may not be generally cylindrical and/or have a generally longitudinal shape. Either or both sections or components may be intended to be disposed of and replaced when exhausted, or be intended for multiple uses enabled by actions such as refilling the reservoir and recharging the battery. In other examples, the system 10 may be unitary, in that the parts of the device 20 and the article 30 are comprised in a single housing and cannot be separated. Embodiments and examples of the present disclosure are applicable to any of these configurations and other configurations of which the skilled person will be aware.

The present disclosure relates to the refilling of a storage area for aerosol generating material in an aerosol provision system, whereby a user is enabled to conveniently provide a system with fresh aerosol generating material when a previous stored quantity has been used up. It is proposed that this be done automatically, by provision of apparatus which is termed herein a refilling device, refilling unit, refilling station, or simply dock. The refilling device is configured to receive an aerosol provision system, or more conveniently, the article from an aerosol provision system, having a storage area which is empty or only partly full, plus a larger reservoir holding aerosol generating material. A fluid communication flow path is established between the reservoir and the storage area, and a controller in the refilling device controls a transfer mechanism or arrangement operable to move aerosol generating material along the flow path from the reservoir to the storage area. The transfer mechanism can be activated in response to user input of a refill request to the refilling device, or activation may be automatic in response to a particular state or condition of the refilling device detected by the controller. For example, if both an article and a reservoir are correctly positioned inside the refilling unit, refilling may be carried out. Once the storage area is replenished with a desired quantity of aerosol generating material (the storage area is filled or a user specified quantity of material has been transferred to the article, for example), the transfer mechanism is deactivated, and transfer ceases. Alternatively, the transfer mechanism may be configured to automatically dispense a fixed quantity of aerosol generating material in response to activation by the controller, such as a fixed quantity matching the capacity of the storage area.

FIG. 2 shows a highly schematic representation of an example refilling device. The refilling device is shown in a simplified form only, to illustrate various elements and their relationship to one another. More particular features of one or more of the elements with which the present disclosure is concerned will be described in more detail below.

The refilling device 50 will be referred to hereinafter for convenience as a “dock”. This term is applicable since a reservoir and an article are received or “docked” in the refilling device during use. The dock 50 comprises an outer housing 52. The dock 50 is expected to be useful for refilling of articles in the home or workplace (rather than being a portable device or a commercial device, although these options are not excluded). Therefore, the outer housing, made for example from metal, plastics or glass, may be designed to have an pleasing outward appearance such as to make it suitable for permanent and convenient access, such as on a shelf, desk, table or counter. It may be any size suitable for accommodating the various elements described herein, such as having dimensions between about 10 cm and 20 cm, although smaller or larger sizes may be preferred. Inside the housing 50 are defined two cavities or ports 54, 56. A first port 54 is shaped and dimensioned to receive and interface with a reservoir 40. The first or reservoir port 54 is configured to enable an interface between the reservoir 40 and the dock 50, so might alternatively be termed a reservoir interface. Primarily, the reservoir interface is for moving aerosol generating material out of the reservoir 40, but in some cases the interface may enable additional functions, such as electrical contacts and sensing capabilities for communication between the reservoir 40 and the dock 50 and determining characteristics and features of the reservoir 40.

The reservoir 40 comprises a wall or housing 41 that defines a storage space for holding aerosol generating material 42. The volume of the storage space is large enough to accommodate many or several times the storage area of an article intended to be refilled in the dock 50. A user can therefore purchase a filled reservoir of their preferred aerosol generating material (flavor, strength, brand, etc.), and use it to refill an article multiple times. A user could acquire several reservoirs 40 of different aerosol generating materials, so as to have a convenient choice available when refilling an article. The reservoir 40 includes an outlet orifice or opening 44 by which the aerosol generating material 42 can pass out of the reservoir 40. In the current context, the aerosol generating material 42 has a liquid form or a gel form, so may be considered as aerosol generating fluid. The term “fluid” may be used herein for convenience to refer to either a liquid or a gel material; where the term “liquid” is used herein, it should be similarly understood as referring to a liquid or a gel material, unless the context makes it clear that only liquid is intended.

A second port 56 defined inside the housing is shaped and dimensioned to receive and interface with an article 30. The second or article port 54 is configured to enable an interface between the article 30 and the dock 50, so might alternatively be termed an article interface. The article interface is for receiving aerosol generating material into the article 30, and according to present example, the article interface enables additional functions, such as electrical contacts and sensing capabilities for communication between the article 30 and the dock 50 and determining characteristics and features of the article 30.

The article 30 itself comprises a wall or housing 31 that has within it (but possibly not occupying all the space within the wall 31) a storage area 3 for holding aerosol generating material. The volume of the storage area 3 is many or several times smaller than the volume of the reservoir 40, so that the article 30 can be refilled multiple times from a single reservoir 40. The article also includes an inlet orifice or opening 32 by which aerosol generating material can enter the storage area 3. Various other elements may be included with the article, as discussed above with regard to FIG. 1. For convenience, the article 30 may be referred to hereinafter as a pod 30.

The housing 52 of the dock also accommodates a fluid conduit 58, being a passage or flow path by which the reservoir 40 and the storage area 3 of the article 30 are placed in fluid communication, so that aerosol generating material can move from the reservoir 40 to the article 30 when both the reservoir 40 and the article 30 are correctly positioned in the dock 50. Placement of the reservoir 40 and the article 30 into the dock 50 locates and engages them such that the fluid conduit 58 is connected between the outlet orifice 44 of the reservoir 40 and the inlet orifice 32 of the article 30. Note that in some examples, all or part of the fluid conduit 58 may be formed by parts of the reservoir 40 and the article 30, so that the fluid conduit is created and defined only when the reservoir 40 and/or the article 30 are placed in the dock 30. In other cases, the fluid conduit 58 may be a flow path defined within a body of the dock 52, to each end of which the respective orifices are engaged.

Access to the reservoir port 54 and the article port 56 can be by any convenient means. Apertures may be provided in the housing 52 of the dock 50, through which the reservoir 40 and the article 30 can be placed or pushed. Doors or the like may be included to cover the apertures, which might be required to be placed in a closed state to allow refilling to take place. Doors, hatches and other hinged coverings, or sliding access elements such as drawers or trays might include shaped tracks, slots or recesses to receive and hold the reservoir 40 or the article 30, which bring the reservoir 40 or the article 30 into proper alignment inside the housing when the door etc. is closed. These and other alternatives will be apparent to the skilled person, and do not affect the scope of the present disclosure.

The dock 50 also includes an aerosol generating material (“liquid” or “fluid”) transfer mechanism, arrangement, apparatus or means 53, operable to move or cause the movement of fluid out of the reservoir 40, along the conduit 58 and into the article 30. Various options are contemplated for the transfer mechanism 53.

A controller 55 is also included in the dock 50, which is operable to control components of the dock 50, in particular to generate and send control signals to operate the transfer mechanism. As noted, this may be in response to a user input, such as actuation of a button or switch (not shown) on the housing 52, or automatically in response to both the reservoir 40 and the article 30 being detected as present inside their respective ports 54, 56. The controller 55 may therefore be communication with contacts and/or sensors (not shown) at the ports 54, 56 in order to obtain data from the ports and/or the reservoir 40 and article 30 that can be used in the generation of control signals for operating the transfer mechanism 53. The controller 55 may comprise a microcontroller, a microprocessor, or any configuration of circuitry, hardware, firmware or software as preferred; various options will be apparent to the skilled person.

Finally, the dock 50 includes a power source 57 to provide electrical power for the controller 53, and any other electrical components that may be included in the dock, such as sensors, user inputs such as switches, buttons or touch panels, and display elements such as light emitting diodes and display screens to convey information about the dock's operation and status to the user. Also, the transfer mechanism may be electrically powered. Since the dock may be for permanent location in a house or office, the power source 57 may comprise a socket for connection of an electrical mains cable to the dock 50, so that the dock 50 may be “plugged in”. Alternatively, the power source may comprise one or more batteries, which might be replaceable or rechargeable, in which case a socket connection for a charging cable can be included.

Further details relating to the control of the refilling will now be described.

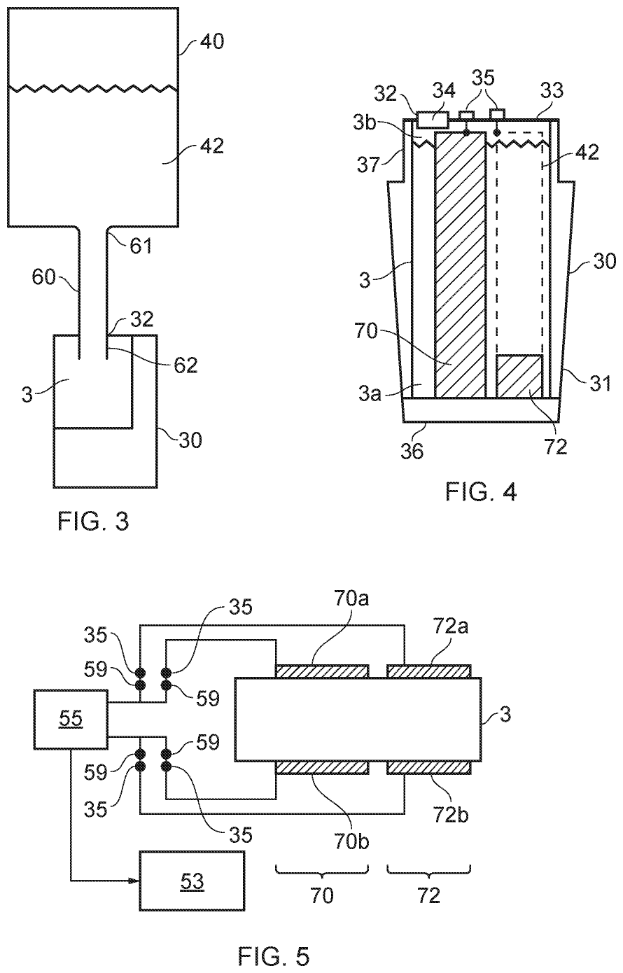

FIG. 3 shows a schematic representation of an article arranged for refilling from a reservoir, where both the reservoir and the article are received in appropriate interfaces in a refilling dock (not shown). A reservoir 40 containing aerosol-generating fluid 42 has a nozzle 60 arranged as its outlet orifice. The nozzle 60 acts as the fluid conduit shown in FIG. 2. In this example, the nozzle has a tubular elongate shape, and extends from the first end 61 to a second or distal end 62, remote from the reservoir 40, which acts as the fluid dispensing point. Fluid is retained in the reservoir by, for example a valve (not shown) at or near the proximal end 61, which is opened when fluid transfer to the article commences. In other cases, surface tension may be sufficient to retain the fluid, for example if the bore of the nozzle is sufficiently small. The distal end 62 is inserted into the inlet orifice 32 of the article 30, and in this example extends directly into the storage area 3 of the article 30. In other examples, there may be tubing, pipework or some other fluid flow path connecting the inlet orifice 32 to the interior of the storage area 3. In use, aerosol-generating material 42 is moved out of the reservoir 40 using the fluid transfer mechanism of the dock, along a fluid channel defined by the nozzle 60 (acting as the fluid conduit) from the proximal end 61 to the distal end 62, where it reaches a fluid outlet of the nozzle and flows into the storage area 3, in order to refill the article 30 with aerosol generating material.

FIG. 3 shows an example arrangement only, and the outlet orifice of the reservoir may be configured other than as a nozzle, and as noted, the fluid conduit that allows refilling of the article using the refilling dock may or may not comprise parts of the reservoir and the article. In general, however, the inlet orifice of the article is configured for engagement with the fluid conduit so that fluid from the reservoir can be ejected from the fluid conduit and into the storage area of the article. Engagement with the fluid conduit may be achieved by relative movement between the article and the end of the fluid conduit (such as the distal end of a nozzle) once the article has been inserted into the article port of the refilling dock.

As noted above, the refilling process is governed by the controller of the refilling device, and includes the generation and sending of control signals to the transfer mechanism to cause it to start the movement of fluid from the reservoir into the article. This can be performed so as to dispense a fixed amount of fluid that corresponds to the known capacity of the article's storage area, after which operation of the transfer mechanism ceases. More usefully, cessation of the fluid dispensing can be implemented in response to detection of a fluid level or amount in the article. The controller is configured to recognize when the storage area has become full, and to cause the transfer mechanism to stop transferring fluid in response. This allows an article to be refilled safely without spilling or pressure build-up in the storage area, regardless of an amount of fluid present in the article at the start of the refilling process. Articles can hence be topped up as well as completely refilled from empty.

In the present disclosure, it is proposed to use capacitance measurements to determine characteristics of fluid in an article received in a refilling device.

In some examples, it is proposed that the capacitance measurements be obtained using capacitor plates incorporated into an article itself. Such an arrangement allows the capacitor plates to be more closely and directly associated with the storage area in an article, to produce more accurate and sensitive measurements.

FIG. 4 shows a schematic representational view of an example article (not to scale). The article 30 is bounded by an outer housing 31 that defines the external shape of the article 30 and forms an interior space for accommodating various elements and parts of the article 30 such as were discussed above with reference to FIG. 1. Of relevance to the present concept, there is shown a storage area 3 for holding fluid aerosol-generating material 42. Other parts not relevant to the concept are not shown for simplicity. The storage area 3 is represented as a simple cylindrical or cuboidal tank, but again this is for simplicity, and the storage area 3 may have any shape in reality, according to the nature of the other parts within the article and the size and shape of the article. For example, the storage area may be annular, defined around a central passage for the flow of air and aerosol, and which may accommodate vapor generating components such as a wick and a heater.

The outer housing 31 is formed from one or more walls, where the number of walls used to assemble the outer housing will be dictated by the design of the article. The article 30 has a somewhat elongate shape, with one end being a mouthpiece end 36. This outer housing slopes inwardly towards the mouthpiece end in order to form a comfortable shape for the mouthpiece. Side walls extend from the mouthpiece end towards a second end of the article 30, opposite to the mouthpiece end 36. Towards the second end, the side walls have a recessed portion 37 for insertion into a receiving socket at an end of a corresponding device in order to create an aerosol generating system. This is an example only, however, and the outer housing may be otherwise shaped.

The article 30 is closed at the second end by a wall 33. This wall 33 includes an inlet orifice 32 by which aerosol-generating material can be added to the storage area for refilling of the article 30, so this wall can be considered as an inlet wall. Note also that in this example, the inlet wall 33 is at an opposite end of the article 30 to the mouthpiece end 36. To allow refilling, the mouthpiece end can be inserted into and held in an article port or interface in a refilling device, leaving the inlet wall exposed for connection with the fluid conduit. For example, the article port may receive the article with the mouthpiece end oriented downwardly, as in FIG. 4, so that the inlet wall faces upwardly for refilling. This can be useful for some internal configurations of article, such as particular vapor generators, or vapor generator and storage area combinations. Also, placement of the inlet orifice in the article wall opposite the mouthpiece will, in general, enable it to be covered when the article is coupled to a device. It is therefore protected from tampering or accidental ingress of contaminants into the storage area. The concept is not limited in this way, however, and the inlet orifice and associated inlet wall can be otherwise located as part of the outer housing 31.

Also shown are electrical contacts 35 for electrical connection of the article 30 to a device with which the article forms an aerosol provision system. Contacts will typically pass through the end wall of the outer housing 31, where in this case the end wall is also the inlet wall 33. The depiction in FIG. 4 is a simplified representation of what may comprise several electrical contacts, placed as shown or otherwise, for various purposes. In the present case, contacts are provided in association with capacitor plates comprised in the article for the detection of fluid during refilling, and which connect with corresponding contacts in the refilling device for communication with the controller of the refilling device.

The article 30 comprises two capacitive sensors, namely a first capacitive sensor 70 and a second capacitive sensor 72. Each capacitive sensor 70, 72 comprises a pair of capacitor plates. The plates of each pair are arranged on or in the article 30 as to be able to measure a capacitance of the storage area 3. To achieve this, each pair of plates is located such that some or all of the volume of the storage area 3 is disposed between the plates. The plates can be located on the inside surface or the outside surface of the wall of the storage area 3, or on the inside surface or the outside surface of the housing 31 of the article 30, or within the housing at an intermediate position between the storage area 3 and the housing 31. In some designs of article, the housing 31 of the article 30 may also provide the wall of the storage area 3. The plates may be cut or stamped from a suitable conductive material and mounted on the relevant wall or housing, or otherwise supported in the article. Alternatively, the plates may be formed by deposition of the conductive material onto the relevant wall or housing. In the depicted arrangement, each capacitive sensor 70, 72 has a first plate on the same side of the storage area, visible in FIG. 4, and a second plate on the opposite side of the storage area, not visible. Electrical connections are formed between each plate and the contacts 35 of the article.

Hence, each capacitive sensor 70, 72 is arranged so that the space between its capacitor plates includes some of the storage volume of the article. When the storage area is empty of aerosol-generating material, a value of capacitance for each sensor exists, depending (in the usual way for a capacitor) on parameters including the area of the plates, the distance between the plates, and the dielectric value of the air occupying the empty storage area. When the storage area is filled with aerosol-generating material, the space between the capacitor plates is occupied with the material, which has a different dielectric constant from air. Hence the capacitance of the sensor is different for a full storage area and an empty storage area. Application of an oscillating voltage across the pair of capacitor plates produces a current flow through the sensor, which can be detected externally in the known manner, and measured to deduce information about the capacitance at the time of measurement. Hence, a capacitance sensing circuit under the control of the controller is provided in the refilling device, together with electrical contacts that make contact with the electrical contacts 35 on the article when the article is received in the article interface. The controller is configured to interrogate the capacitance of the capacitive sensors, and can identify a full storage area and an empty storage area from the measurements.

The capacitance is changed by the presence of aerosol generating material in the storage area, and this change is gradual over the process of refilling the storage area, from the value for an empty storage area to the value for a full storage area, as the increasing amount of fluid displaces the air in the storage area. Hence, intermediate amounts of aerosol-generating material can also be measured, with suitable calibration, and providing the controller with a relationship between fluid amount or level and measured capacitance or detected current so that the fluid amount can be determined from measurements obtained from the capacitive sensors.

While this can be achieved to at least some extent for many configurations of capacitor plate, a full range of fluid level measurement can be obtained by use of a capacitive sensor that extends over the full height or depth of the storage area. This is shown in the example of FIG. 4, where the plates of the first capacitive sensor 70 have a length that reaches from the base or lower end 3a of the storage area 3 to the top or upper end 3b of the storage area 3. This is the height of the storage area 3 when the article 30 is oriented vertically, as depicted, for refilling through the inlet orifice 34 in its end wall 33. Accordingly, the height of the storage area 3 corresponds to the direction of rising or increasing fluid level as aerosol-generating material is added to the storage area during refilling, and the capacitor plates extends along this direction. The plates of the first capacitive sensor 70 extend from the base 3a of the storage area 3, where the fluid level is zero or near-zero when the storage area 3 is empty, to the top 3b of the storage area 3 where the fluid level reaches when the storage area 3 is filled to its maximum capacity when full of aerosol generating material. In other examples, the plates of the first capacitor 70 may extend less far along the height of the storage area 3, for example to detect a fluid level which is a predetermined level or capacity of interest for the storage area which may be a partial capacity or the full capacity. Measurement down to zero level may also not be of interest, and detection of fluid levels close to full capacity considered adequate, so that the plates do not need to reach to the base of the storage area 3. However, the arrangement shown in FIG. 4 offers the largest measurement range.

The article includes also the second capacitive sensor 72. The electrical connections and contacts in the article 30 and the refilling device, and the capacitance detection circuitry, are configured so that the second capacitive sensor 72 can be used or interrogated separately from the first capacitive sensor 70, to obtain first capacitance measurements and second capacitance measurements. Since a purpose of the capacitance measurements is to determine information about the level or volume of aerosol generating material in the article's storage area, and its relationship to the maximum capacity of the storage area, the plates of the second capacitive sensor 72 also extend along the direction of increasing fluid level during refilling. The second capacitance measurement may be used in various ways in conjunction with the first capacitance measurement, in order to improve the first capacitance measurement, and the size of the second sensor's plates can be chosen accordingly. They may extend for the same distance or length as the plates of the first capacitive sensor 70, such as over the full height of the storage tank from empty to full (maximum capacity), which is shown in phantom in FIG. 4. Alternatively, the second plates may be smaller in area than the first plates, so as to detect changes in fluid level over a lesser proportion of the volume of the storage area 3. For example, the length or dimension of the second plates along the refilling direction may be less than the length or dimension of the first plates, as illustrated in FIG. 4. In particular, the FIG. 4 example shows the plates of the second capacitive sensor 72 located so as to extend from the zero fluid level at the base 3a of the storage area to a partial fluid level corresponding to less than the maximum capacity of the storage area 3. Hence, only a lower portion of the storage area 3 is covered by the second capacitive sensor 72. The lower portion might be up to 20% of the full capacity of the storage area, such as 5%, 10% or 15%, although other values not more than 20% may be used. For some applications, values in the range from 20% to 100% (full capacity) might be chosen for the extent of the second capacitive sensor 72. The configuration shown in FIG. 4 can be summarised as the plates of the first sensor and the plates of the second sensor both having an extent along the direction of increasing fluid level during refilling (refilling direction), where the second sensor plates can be shorter than the first sensor plates along this direction, and the first sensor plates and the second sensor plates are parallel to one another and side-by-side with respect to the refilling direction. In this way, at least part of the range or extent of the refilling direction is covered by both sensors. However, other configurations of two capacitive sensors for an article are not excluded. The capacitor plates have a width in a direction orthogonal to the refilling direction. In some examples the first capacitor plates can have the same width as the second capacitor plates since this can make measurements from the two sensors more readily comparable or combinable (capacitance being proportional to plate area). However, different widths might be used, for example to fit more conveniently with other components of the article, and a suitable adjustment be made when processing the capacitance measurements.

FIG. 5 shows a schematic representation of the capacitive sensor arrangement, seen from above, in other words viewed along the direction of refilling. The storage area 3 has a rectangular cross-section in this plane (orthogonal to the refilling direction). The first pair of plates 70a, 70b making up the first sensor 70, are arranged on the outer surface of the opposite long sides of the rectangle, as are the second pair of plates 72a, 72b making up the second sensor 72. The first pair of plates 70a, 70b are next to the second pair of plates 72a, 72b. For a rectangular cross-section of tank, this gives the two sensors the same spacing between plates, for ease of comparison between measurements. This is not essential however, and the pairs of plates may be differently disposed, with compensation for different spacings applied to the capacitance measurements if required. Each plate has an electrical connection to an electrical contact 35 arranged on the exterior of the article (not shown). When the article is installed in the refilling device, the contacts 35 on the article are aligned with and hence connect to appropriate contacts 59 in the refilling device which place the capacitive sensors in electrical communication with the controller 55 and associated capacitance detection circuitry, which can be configured in a usual manner. The controller 55 is configured, via suitable programming for example, to determine the level or amount of aerosol-generating material in the storage area from the capacitance measurements it obtains from the first and second capacitive sensors 70, 72. In response, the controller 55 generates and sends control signals to the transfer mechanism 53 to cause the transfer mechanism 53 to stop, start or otherwise vary its action to move fluid from the reservoir to the article.

Usefully, the controller and any associated circuitry can be configured to interrogate the first capacitive sensor 70 and the second capacitive sensor 72 separately, in order to obtain individual first capacitance measurements and second capacitance measurements. Since the plates of the first sensor 70 and the second sensor 72 are close together, owing to the inevitable small size of an article, some interference may occur between the two sensors. Therefore, the plates of one sensor might be grounded (earthed) while measurements are being obtained from the other sensor, and vice versa. The controller can be configured to switch, possibly rapidly (depending on the resolution of measurement required), back and forth between the two sensors over all or part of the refilling of the article.

As a particular example of refilling control based on capacitive sensor measurements, the controller can be configured to use the capacitance measurements to ascertain when the article has become full (or has reached some other predefined fluid level) during the refilling process, and in response, control the transfer mechanism to cease the movement of aerosol generating material from the reservoir to the article. The refilled article can then be removed from the refilling device by the user, and utilized again in an aerosol-generation system.

While capacitance measurements from the first capacitive sensor alone can be used to detect a full article storage area, it is proposed herein that benefits can be obtained by also using capacitance measurements from the second capacitive sensor to modify, adjust, correct, calibrate, enhance or improve the first capacitance measurements to more accurately determine the fluid level in the article. In this way, a refilling action can be terminated more appropriately to achieve a desired refill level in the article, reducing the chances of overfilling or underfilling. Overfilling can increase pressure in the storage area, increasing the change of leaks and spills. Underfilling means that the article becomes empty again more quickly, requiring more frequent refilling actions to be undertaken. Accordingly, it is proposed that both first capacitance measurements and second capacitance measurements are retrieved or obtained during refilling, and both measurements processed in order to determine when the required amount of aerosol generating material has been delivered (in other words, the storage area has been filled to a predetermined desired capacity, such as completely full or maximum capacity), in response to which refilling ceases.

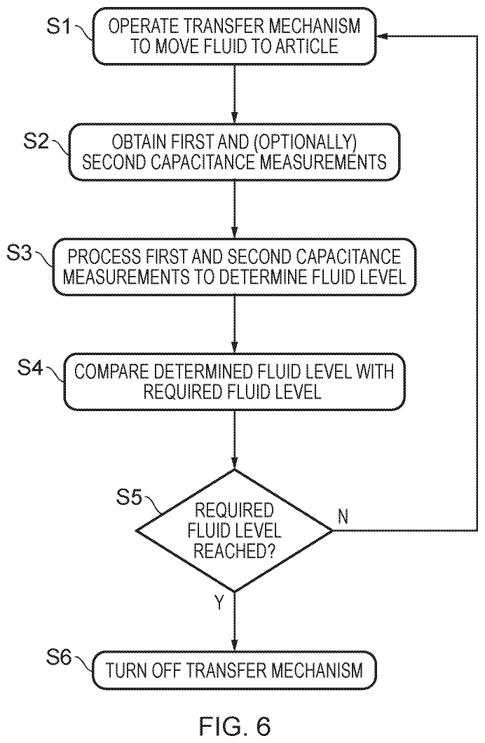

FIG. 6 shows a flow chart of an example of a method for refilling an article with capacitive sensor control. In a first step S1, a refilling is carried in the refilling device, under the control of the controller, by operating the transfer mechanism to move fluid from the reservoir into the article. During the refilling, first capacitance measurements are obtained from the first capacitive sensor and second capacitance measurements are obtained from the second capacitive sensor, in a second step S2. In a third step S3, the first capacitance measurements and the second capacitance measurements are processed by the controller in order to derive or determine a value for the current fluid level or amount in the article. An actual fluid level value may be determined, or the data may be left in terms of capacitance where it is known how capacitance values map to fluid level values. Moving to a next step S4, the determined fluid level is compared with a predetermined required fluid level, such as the level at which the storage area is filled to maximum capacity. As in step S3, the determined and required fluid levels may be actual fluid levels or amounts (such as weight or volume of fluid) or may be expressed in terms of capacitance, in order to reduce the number of processing steps. In step S5, the result of the comparison is assessed. If it is found that yes, the required fluid level has been reached (or exceeded), the method moves to the final step S6, and the transfer mechanism is turned off so that movement of fluid into the article ceases and the refilling action is terminated. On the other hand, if it is found in step S5 that no, the required fluid level has not yet been reached, the method returns to step S1 so that fluid movement into the article continues. In successive loops of the method, additional measurements of the second capacitance may not be needed, so in step S2, obtaining the second capacitance measurement may be optional, depending on the use to which the second capacitance measurement is put.

The second capacitance measurement can be utilized in a variety of ways. For example, the second capacitive sensor can be configured to have the same extent along the refilling direction as the first capacitive sensor (an example of which is shown in phantom in FIG. 6). Both sensors can therefore measure fluid level over the full depth of the storage area, and detect that the fluid level has reached the required level. Accordingly, processing of the first capacitance measurement and the second capacitance measurement can include averaging of the two measurements to produce a single indication of fluid level for comparison with the required level. This can be implemented with smaller capacitive sensors too, for example, which extend over a shorter height of the storage area that includes the maximum fill level but not the zero and lower fill levels.

In other examples, the second capacitance measurement can be used to provide a correction or adjustment to the first capacitance measurement in order to improve accuracy. Various conditions and circumstances may alter capacitance measurements from an expected value. In the present application of comparing a fluid level determined from a capacitance measurement with a required fluid level, any variation in the determined fluid level will affect when the required fluid level is found to be reached, possible giving small errors of overfilling or underfilling. As an example, the dielectric properties of the aerosol generating material can vary with temperature, so that the capacitance detected for any given fluid level can similarly vary with temperature.

Accordingly, in some examples it is proposed that the second capacitive sensor be used as a reference sensor, providing a capacitance measurement that can be used to compensate for fluctuations in environmental conditions, such as temperature. For this function, the second capacitive sensor may be configured as the non-phantom configuration in FIG. 4, in other words, having an extent along the refilling direction which is less than that of the first capacitive sensor, and optionally significantly less. If the plates of the second capacitive sensor are located towards the base of the storage area, possibly covering the zero fill level, the space between the plates inside the storage area is filled with fluid early in the refilling process. As the fluid level moves up the extent of the second sensor plates, the capacitance changes, but once the fluid level has passed the upper edge of the plates, there is no longer any significant variation in the space between the plates, and the capacitance value saturates. The capacitance remains largely invariant with further increases in fluid level. Hence, the capacitance measurement from the second capacitive sensor can be treated as representing the characteristics or properties of the aerosol-generating material at that time, and used to compensate the reading from the first capacitive sensor. For example, if the temperature of the fluid at the time of refilling is such as to increase the capacitance, both the first and the second capacitance measurements will be higher, but the second measurement will be a substantially fixed value after saturation. The first measurement will vary with increasing fluid level, with regard to a higher base level caused by the temperature. Subtraction (or a similar mathematical process) of the second measurement from the first measurement (plus any manipulation to adjust for differences between the sensors such as different plate size or separation) will leave only the part of the second measurement caused by the fluid level, so the effect of temperature is removed, and a more accurate determination of the fluid level can be reached.

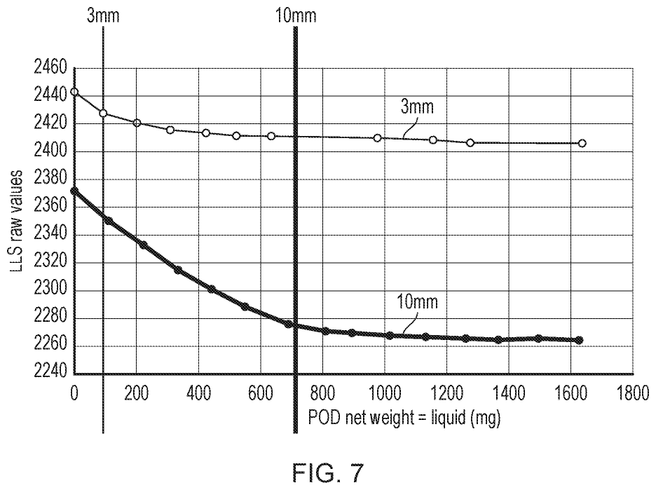

FIG. 7 shows a graph of capacitance variation with fluid amount in a storage area measured experimentally for two different capacitance sensors. The capacitance sensors are both second capacitance sensors configured as just described to extend upwards from the base of the storage area for a distance less than the full height of the storage area. The storage area had a height of 23 mm. One sensor had capacitor plates of 10 mm extent along the refilling direction, and the other sensor had capacitor plates of 3 mm extent along the refilling direction. The graph shows the capacitance (as raw output from the sensors; vertical axis) measured with increasing amount of fluid in the storage area (as the weight of the article or pod; horizontal axis). The vertical lines indicate the fluid amounts or fill level corresponding to the maximum heights of the sensor plates, in other words, the points at which the two sensors become saturated. As expected, the measured capacitance changes gradually and steadily (in this example, decreases) with increasing fluid level until the top edge of the sensor plates is passed. Beyond this point, the measured capacitance plateaus off, and no significant further change is observed. This is the saturated value for the capacitor sensor, which can be used to correct or adjust the output of a first capacitance sensor configured for detecting fluid level. Accordingly, it may be deemed unnecessary to continue to retrieve capacitance values for the second capacitive sensor over the whole of the refilling time. Instead, measurements could cease after saturation is reached, with the final value being taken as the second capacitance measurement. A single measurement could be taken when it is known that the fill level has passed the saturation level. Alternatively, measurements could continue, and an average saturation value be calculated from multiple measurements obtained across the saturation plateau.

Regardless of how many measurements are taken from the second capacitive sensor, a better correction of the first capacitance measurement may be obtained if the second capacitance measurement saturates relatively early in the refilling process. Therefore, a short sensor may be preferred, by which is meant second capacitor plates which extend a relatively small distance along the refilling direction. For example, a height of not more than 20% of the depth of the storage area up to the maximum capacity is useful, such as 5% or 10% or 25%. This smaller height can also be expressed as a proportion of the corresponding dimension of the first capacitive sensor plates (regardless of how much of the tank height is covered by the first capacitive sensor). So, the plates of the second sensor may have a dimension along the refilling direction which is not more than 20% (for example 5%, 10%, 15% or 20%) of the dimension of the plates of the first sensor along the refilling direction.

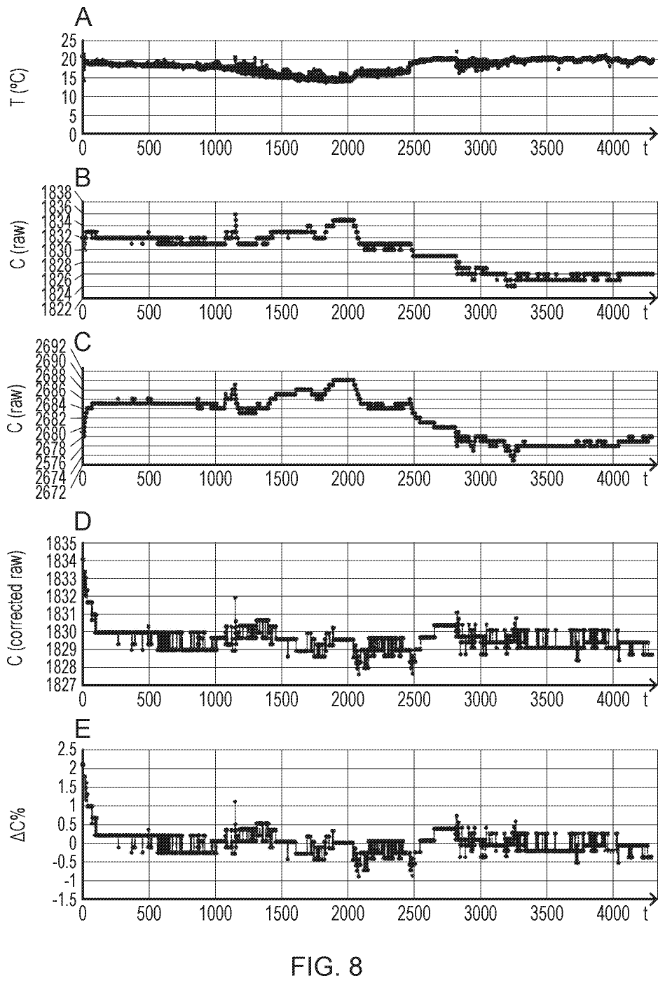

FIGS. 8A-8E show graphs of data obtained from an experimental investigation of temperature correction of fluid level sensing with two capacitive sensors.

FIG. 8A shows the temperature T of aerosol generating material in an article's storage area, measured over a 24 hour period. The storage area was filled and remained full over the measurement period. Some temperature variation around room temperature (20° C.) can be seen, with a slight upward trend over the measurement period.

FIG. 8B shows capacitance measurements C (as raw data) collected from a first capacitive sensor configured to detect fluid to the maximum capacity of the article, over the same 24 hour period. Although the storage area remained full so that the fluid level was constant over this time, the measured capacitance shows a variation. Note that the variation follows the varying temperature shown in FIG. 8A, with a higher temperature reducing the capacitance measurement, so the overall trend is downwards over the measurement period. Hence, changes in temperature can be considered to be a significant influencing factor on capacitance-based detection of fluid level.

FIG. 8C shows capacitance measurements C (as raw data) collected from a second capacitive sensor configured as a reference sensor as described, having a smaller height that the first capacitive sensor. Comparison with FIG. 8B shows that the overall variation over time is very similar, again following the temperature fluctuations. Note that the magnitude of the second capacitance measurements differ from the first capacitance measurements, owing to the different sizes of the capacitor plates.

FIG. 8D shows the first capacitance measurements of FIG. 8B compensated or corrected using the second capacitance measurements of FIG. 8C. Note that the downward trend over time arising from the temperature increase has been removed, giving a much more horizontal line, reflecting the constant amount of fluid in the article. Fluctuations are also much smaller than the uncompensated measurement.

FIG. 8E shows the calculated percentage error in the compensated first capacitance measurements. The error largely lies in the +0.5% range, showing that the proposed method of correcting fluid level measurements is very useful.

In some designs of article, the cross-section through the storage area and associated capacitor plates (such as the example of FIG. 5) remains substantially constant along the direction of refilling. In such a case, the relationship between capacitance measured at the first capacitive sensor and the amount of aerosol generating material in the storage area can be substantially linear, with the capacitance changing upwardly or downwardly (depending on the dielectric properties of the material) at a relatively constant rate as the material occupies an increasing amount of the space between the capacitor plates. However, in other designs, the cross-sectional configuration is not constant with height of the article. For example, an annular storage area may surround a central airflow channel that has items within it such as a heater and a wick. The airflow channel may not be constant width. The side walls of the storage area may not be vertical. The capacitor plates may not be vertical. Other components of the article may be interposed between the capacitor plates and the storage area. Any of these and other configurations mean that at any given height, the materials between the capacitor plates may be different from at some other height, and/or a different amount of fluid can be present in the space between the plates, and/or the separation of the plates is different. Hence, the change in capacitance wrought by the addition of fluid has a varying rate with height of the storage area. There is a nonlinear relationship between measured capacitance and liquid level. Preferably, therefore, the controller should be calibrated so as to apply the relevant nonlinear relationship when determining whether the storage area contains the required amount of aerosol-generating material.

The examples of FIGS. 4 and 5 show capacitor plates of both the first capacitor and the second capacitor configured as planar elements. This is not essential, however, and the plates may be otherwise shaped and located as convenient within the overall configuration of the article. As a further alternative, a heating element in the article might be used as a capacitor plate for one or both of the capacitive sensors, if it is provided with suitable electrical connections and is situated within the outer confines of the storage area in an appropriate location. For example, an elongate heating element that extends along the same direction as the refilling direction could be used as a plate for the first capacitive sensor. A heating element with a lesser extent in this direction could be used a plate for the second capacitive sensor.

The examples discussed thus far have incorporated at least the capacitor plates of the capacitive sensors into the article. The bulk of the capacitance detector circuitry is conveniently included in the refilling device, but some or all might be included in the article. The precise division of capacitance sensing parts between the article and the refilling device is unimportant, so long as the controller in the refilling device is able to obtain capacitance measurements relating to the storage area in the article. Placement of the capacitor plates in the article allows the plates to be very close to the storage area, reducing the distance between the plates and the amount of extraneous components between the plates. However, this can increase the cost and complexity of the article. A similar result can be obtained by incorporating one or more of the capacitor plates into the article interface of the refilling unit, appropriately positioned such that the storage area lies in the spaces between the pairs of capacitor plates when the article is correctly inserted into the article interface, ready for refilling. In such an arrangement, the capacitor sensing can also be used by the controller to detect the presence of an article in the refilling device, in response to which a refilling action may be initiated.

Further in this regard, the refilling device may include a separate sensor or sensors configured to allow the controller to detect the presence of an article in the refilling device. The separate sensor may or may not be a capacitive sensor, and may be used in combination with the fluid level capacitive sensors either in the article or in the refilling dock. The output of the separate sensor can be used to check that the article is present and properly located in the refilling device so that it is appropriate to initiate a filling action. Also, a check for a correct location of the article before the capacitive measurements commence indicates that the capacitive sensors are also properly positioned with respect to the article and/or the refilling device. This allows the capacitive measurements obtained from the capacitive sensors to be deemed accurate. Incorrect measurements and readings, which can erroneously indicate that the article is or is not filled as required, can thereby be avoided.

Regardless of where in the article or the refilling device the capacitor plates of the capacitive sensors are located, one or more electromagnetic shields may be included in association with the plates. Any such shield can isolate the plates from any stray electromagnetic fields that may cause interference and introduce errors into the capacitance measurements. The accuracy of the measurements can thereby be enhanced.

An additional or alternative technique for improving accuracy is for the controller to take account of other measurements, detections or readings in combination with the capacitance measurements when determining if the fluid level in the storage area has reached the required fluid level. An unexpected discrepancy between information from two different sources both able to provide an indication of fluid level in the storage area can be taken as evidence of a measurement error. This can be used to cause the controller to cease the filling action, and/or return an error notification or message to the user via a display or similar on the refilling dock. As an example, the controller may monitor the operation of the transfer mechanism as it operates to move fluid from the reservoir to the storage area. A function such as the duration of operation of the transfer mechanism or the distance moved by a moving part comprised in the transfer mechanism could be used to estimate an amount of fluid which has been transferred. This estimate can be cross-checked with the fluid level ascertained from the capacitive sensors to identify or reveal inaccuracies.

In accordance with another aspect of the disclosure, the following is provided.

In some embodiments, the non-combustible aerosol provision system is an aerosol-generating material heating system, also known as a heat-not-burn system. An example of such a system is a tobacco heating system.

In some embodiments, the disclosure relates to consumables comprising aerosol-generating material and configured to be used with non-combustible aerosol provision devices. These consumables are sometimes referred to as articles throughout the disclosure.

In some embodiments, the area for receiving aerosol-generating material may be separate from, or combined with, an aerosol generating area. (which is an area at which the aerosol is generated). In some embodiments, the article for use with the non-combustible aerosol provision device may comprise a filter and/or an aerosol-modifying agent through which generated aerosol is passed before being delivered to the user.

In some examples, the present disclosure relates to aerosol provision systems and components thereof that utilize aerosol-generating material in the form of a liquid, gel or a solid which is held in an aerosol-generating material storage area such as a reservoir, tank, container or other receptacle comprised in the system, or absorbed onto a carrier substrate. An arrangement for delivering the aerosol-generating material from the aerosol-generating material storage area for the purpose of providing it to an aerosol generator for vapor/aerosol generation is included. The terms “liquid”, “gel”, “solid”, “fluid”, “source liquid”, “source gel”, “source fluid” and the like may be used interchangeably with terms such as “aerosol-generating material”, “aerosolizable substrate material” and “substrate material” to refer to material that has a form capable of being stored and delivered in accordance with examples of the present disclosure.

As used herein, “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid. In some embodiments, the aerosol-generating material may comprise one or more active constituents, one or more flavors, one or more aerosol-former materials, and/or one or more other functional materials. The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical. As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof. The aerosol-former material may comprise one or more constituents capable of forming an aerosol. In some embodiments, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. The one or more other functional materials may comprise one or more of pH regulators, coloring agents, preservatives, binders, fillers, stabilizers, and/or antioxidants.

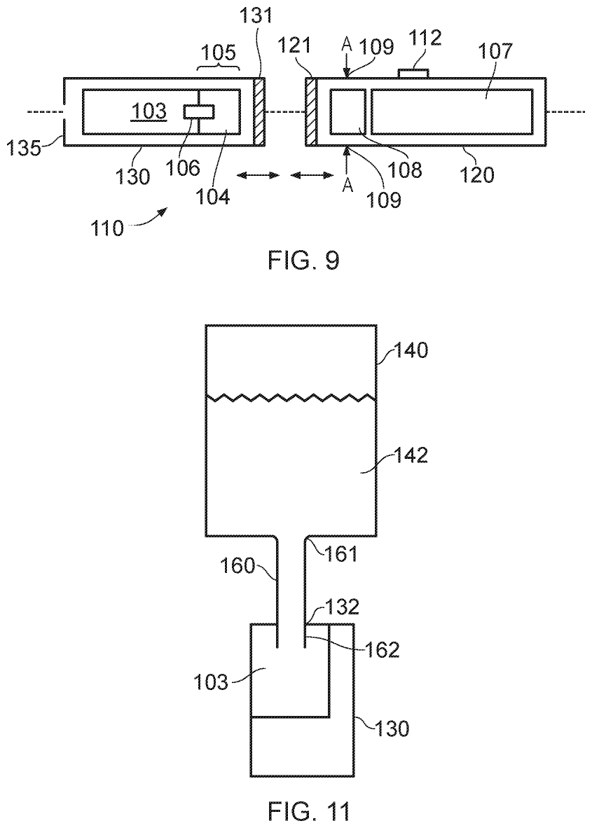

FIG. 9 is a highly schematic diagram (not to scale) of an example electronic aerosol/vapor provision system 110, presented for the purpose of showing the relationship between the various parts of a typical system and explaining the general principles of operation. Note that the present disclosure is not limited to a system configured in this way, and features may be modified in accordance with the various alternatives and definitions described above and/or apparent to the skilled person.

The aerosol provision system 110 has a generally elongate shape in this example, extending along a longitudinal axis indicated by a dashed line, and comprises two main components, namely an aerosol provision device 120 (control or power component, section or unit), and an article or consumable 130 (cartridge assembly or section, sometimes referred to as a cartomiser, clearomiser or pod) carrying aerosol-generating material and operable to generate vapor/aerosol. In the following description, the aerosol provision system 110 is configured to generate aerosol from a liquid aerosol-generating material (source liquid), and the foregoing disclosure will explain the principles of the present disclosure using this example. However, the present disclosure is not limited to aerosolizing a liquid aerosol-generating material, and features may be modified in accordance with the various alternatives and definitions described above and/or apparent to the skilled person in order to aerosolize different aerosol-generating materials, e.g., solid aerosol-generating materials or gel aerosol-generating materials as described above.

The article 130 includes a reservoir 103 (as an example of an aerosol-generating material storage area) for containing a source liquid from which an aerosol is to be generated, for example containing nicotine. As an example, the source liquid may comprise around 1% to 3% nicotine and 50% glycerol, with the remainder comprising roughly equal measures of water and propylene glycol, and possibly also comprising other components, such as flavorings. Nicotine-free source liquid may also be used, such as to deliver flavoring. In some embodiments, a solid substrate (not illustrated), such as a portion of tobacco or other flavor imparting element through which vapor generated from the liquid is passed, may also be included. The reservoir 103 may have the form of a storage tank, being a container or receptacle in which source liquid can be stored such that the liquid is free to move and flow within the confines of the tank. In other examples, the storage area may comprise absorbent material (either inside a tank or similar, or positioned within the outer housing of the article) that substantially holds the aerosol-generating material. For a consumable article, the reservoir 103 may be sealed after filling during manufacture so as to be disposable after the source liquid is consumed. However, the present disclosure is relevant to refillable articles that have an inlet port, orifice or other opening (not shown in FIG. 9) through which new source liquid can be added to enable reuse of the article 130.

The article 130 also comprises an aerosol generator 105, which may have the form of an electrically powered heating element or heater 104 and an aerosol-generating material transfer component 106 designed to transfer aerosol-generating material from the aerosol-generating material storage area to the aerosol generator). The heater 104 is located externally of the reservoir 103 and is operable to generate the aerosol by vaporization of the source liquid by heating. The aerosol-generating material transfer component 106 is a transfer or delivery arrangement configured to deliver aerosol-generating material from the reservoir 103 to the heater 104. In some examples, it may have the form of a wick or other porous element. A wick 106 may have one or more parts located inside the reservoir 103, or otherwise be in fluid communication with liquid in the reservoir 103, so as to be able to absorb source liquid and transfer it by wicking or capillary action to other parts of the wick 106 that are adjacent or in contact with the heater 104. The wick may be formed of any suitable material which can cause wicking of the liquid, such as glass fibers or cotton fibers. This wicked liquid is thereby heated and vaporized, and replacement liquid is drawn, via continuous capillary action, from the reservoir 103 for transfer to the heater 104 by the wick 106. The wick 106 may be thought of as a conduit between the reservoir 103 and the heater 104 that delivers or transfers liquid from the reservoir to the heater. In some implementations, the heater 104 and the aerosol-generating material transfer component 106 are unitary or monolithic, and formed from a same material that is able to be used for both liquid transfer and heating, such as a material which is both porous and conductive. In still other cases, the aerosol-generating material transfer component 106 may operate other than by capillary action, such as by comprising an arrangement of one or more valves by which liquid may exit the reservoir 103 and be passed onto the heater 104.

A heater and wick (or similar) combination, referred to herein as an aerosol generator 105, may sometimes be termed an atomiser or atomiser assembly, and the reservoir with its source liquid plus the atomiser may be collectively referred to as an aerosol source. Various designs are possible, in which the parts may be differently arranged compared with the highly schematic representation of FIG. 9. For example, and as mentioned above, the wick 106 may be an entirely separate element from the heater 104, or the heater 104 may be configured to be porous and able to perform at least part of the wicking function directly (a metallic mesh, for example).

In the present example, the system is an electronic system, and the heater 104 may comprise one or more electrical heating elements that operate by ohmic/resistive (Joule) heating. The article 130 may comprise electrical contacts (not shown) at an interface of the article 130 which electrically engage to electrical contacts (not shown) at an interface of the aerosol provision device 120. Electrical energy can therefore be transferred to the heater 104 via the electrical contacts from the aerosol provision device 120 to cause heating of the heater 104. In other examples, the heater 104 may be inductively heated, in which case the heater comprises a susceptor in an induction heating arrangement which may comprise a suitable drive coil through which an alternating electrical current is passed. A heater of this type could be configured in line with the examples and embodiments described in more detail below.

In general, therefore, an aerosol generator in the present context can be considered as one or more elements that implement the functionality of an aerosol-generating element able to generate vapor by heating source liquid (or other aerosol-generating material) delivered to it, and a liquid transport or delivery element able to deliver or transport liquid from a reservoir or similar liquid store to the vapor-generating element by a wicking action/capillary force or otherwise. An aerosol generator is typically housed in an article 130 of an aerosol generating system, as in FIG. 9, but in some examples, at least the heater part may be housed in the device 120. Embodiments of the disclosure are applicable to all and any such configurations which are consistent with the examples and description herein.

Returning to FIG. 9, the article 130 also includes a mouthpiece or mouthpiece portion 135 having an opening or air outlet through which a user may inhale the aerosol generated by the heater 104.

The aerosol provision device 120 includes a power source such as a cell or battery 107 (referred to hereinafter as a battery, and which may or may not be re-chargeable) to provide electrical power for electrical components of the aerosol provision system 110, in particular to operate the heater 104. Additionally, there is control circuitry 108 such as a printed circuit board and/or other electronics or circuitry for generally controlling the aerosol provision system 110. The control circuitry 108 may include a processor programmed with software, which may be modifiable by a user of the system. The control circuitry 108, in one aspect, operates the heater 104 using power from the battery 107 when vapor is required. At this time, the user inhales on the system 110 via the mouthpiece 135, and air A enters through one or more air inlets 109 in the wall of the device 120 (air inlets may alternatively or additionally be located in the article 130). When the heater 104 is operated, it vaporizes source liquid delivered from the reservoir 103 by the aerosol-generating material transfer component 106 to generate the aerosol by entrainment of the vapor into the air flowing through the system, and this is then inhaled by the user through the opening in the mouthpiece 135. The aerosol is carried from the aerosol generator 105 to the mouthpiece 135 along one or more air channels (not shown) that connect the air inlets 109 to the aerosol generator 105 to the air outlet when a user inhales on the mouthpiece 135.

More generally, the control circuitry 108 is suitably configured/programmed to control the operation of the aerosol provision system 110 to provide conventional operating functions of the aerosol provision system in line with established techniques for controlling such devices, as well as any specific functionality described as part of the foregoing disclosure. The control circuitry 108 may be considered to logically comprise various sub-units/circuitry elements associated with different aspects of the aerosol provision system's operation in accordance with the principles described herein and other conventional operating aspects of aerosol provision systems, such as display driving circuitry for systems that may include a user display (such as an screen or indicator) and user input detections via one or more user actuatable controls 112. It will be appreciated that the functionality of the control circuitry 108 can be provided in various different ways, for example using one or more suitably programmed programmable computers and/or one or more suitably configured application-specific integrated circuits/circuitry/chips/chipsets configured to provide the desired functionality.

The device 120 and the article 130 are separate connectable parts detachable from one another by separation in a direction parallel to the longitudinal axis, as indicated by the double-headed arrows in FIG. 9. The components 120, 130 are joined together when the system 110 is in use by cooperating engagement elements 121, 131 (for example, a screw or bayonet fitting) which provide mechanical and in some cases electrical connectivity between the device 120 and the article 130. Electrical connectivity is required if the heater 104 operates by ohmic heating, so that current can be passed through the heater 104 when it is connected to the battery 105. In systems that use inductive heating, electrical connectivity can be omitted if no parts requiring electrical power are located in the article 130. An inductive work coil/drive coil can be housed in the device 120 and supplied with power from the battery 105, and the article 130 and the device 120 shaped so that when they are connected, there is an appropriate exposure of the heater 104 to flux generated by the coil for the purpose of generating current flow in the material of the heater. The FIG. 9 design is merely an example arrangement, and the various parts and features may be differently distributed between the device 120 and the article 130, and other components and elements may be included. The two sections may connect together end-to-end in a longitudinal configuration as in FIG. 9, or in a different configuration such as a parallel, side-by-side arrangement. The system may or may not be generally cylindrical and/or have a generally longitudinal shape. Either or both sections or components may be intended to be disposed of and replaced when exhausted, or be intended for multiple uses enabled by actions such as refilling the reservoir and recharging the battery. In other examples, the system 110 may be unitary, in that the parts of the device 120 and the article 130 are comprised in a single housing and cannot be separated. Embodiments and examples of the present disclosure are applicable to any of these configurations and other configurations of which the skilled person will be aware.

The present disclosure relates to the refilling of a storage area for aerosol generating material in an aerosol provision system, whereby a user is enabled to conveniently provide a system with fresh aerosol generating material when a previous stored quantity has been used up. It is proposed that this be done automatically, by provision of apparatus which is termed herein a refilling device, refilling unit, refilling station, or simply dock. The refilling device is configured to receive an aerosol provision system, or more conveniently, the article from an aerosol provision system having a storage area which is empty or only partly full, plus a larger reservoir holding aerosol generating material. A fluid communication flow path is established between the larger reservoir and the storage area, and a controller in the refilling device controls a transfer mechanism (or arrangement) operable to move aerosol-generating material along the flow path from the larger reservoir in the refilling device to the storage area. The transfer mechanism can be activated in response to user input of a refill request to the refilling device, or activation may be automatic in response to a particular state or condition of the refilling device detected by the controller. For example, if both an article and a larger reservoir are correctly positioned inside or otherwise coupled to the refilling unit, refilling may be carried out. Once the storage area is replenished with a desired quantity of aerosol generating material (the storage area is filled or a user specified quantity of material has been transferred to the article, for example), the transfer mechanism is deactivated, and transfer ceases. Alternatively, the transfer mechanism may be configured to automatically dispense a fixed quantity of aerosol generating material in response to activation by the controller, such as fixed quantity matching the capacity of the storage area.

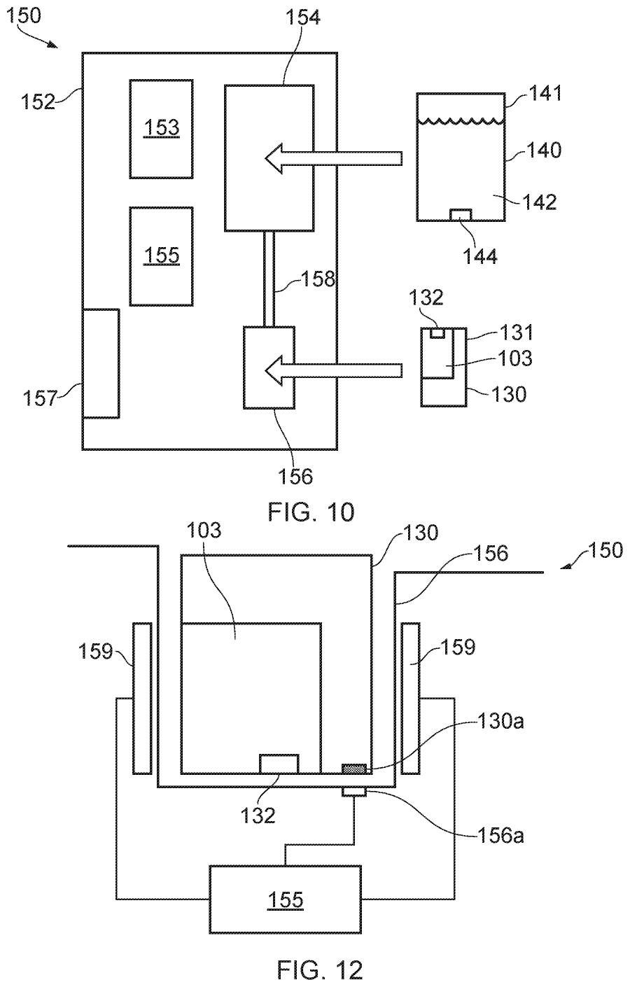

FIG. 10 shows a highly schematic representation of an example refilling device. The refilling device is shown in a simplified form only, to illustrate various elements and their relationship to one another. More particular features of one or more of the elements with which the present disclosure is concerned will be described in more detail below.

The refilling device 150 will be referred to hereinafter for convenience as a “dock”. This term is applicable since a reservoir and an article are received or “docked” in the refilling device during use. The dock 150 comprises an outer housing 152. The dock 150 is expected to be useful for refilling of articles in the home or workplace (rather than being a portable device or a commercial device, although these options are not excluded). Therefore, the outer housing, made for example from metal, plastics or glass, may be designed to have an pleasing outward appearance such as to make it suitable for permanent and convenient access, such as on a shelf, desk, table or counter. It may be any size suitable for accommodating the various elements described herein, such as having dimensions between about 10 cm and 20 cm, although smaller or larger sizes may be preferred. Inside the housing 150 are defined two cavities or ports 154, 156.

A first port 154 is shaped and dimensioned to receive and interface with a refill reservoir 140. The first or refill reservoir port 154 is configured to enable an interface between the refill reservoir 140 and the dock 150, so might alternatively be termed a refill reservoir interface. Primarily, the refill reservoir interface is for moving aerosol-generating material out of the refill reservoir 140, but as described below, in some cases the interface may enable additional functions, such as electrical contacts and sensing capabilities for communication between the refill reservoir 140 and the dock 150 and determining characteristics and features of the refill reservoir 140.

The refill reservoir 140 comprises a wall or housing 141 that defines a storage space for holding aerosol-generating material 142. The volume of the storage space is large enough to accommodate many or several times the storage area/reservoir 103 of an article 130 intended to be refilled in the dock 150. A user can therefore purchase a filled reservoir 140 of their preferred aerosol generating material (flavor, strength, brand, etc.), and use it to refill an article 130 multiple times. A user could acquire several reservoirs 140 of different aerosol generating materials, so as to have a convenient choice available when refilling an article. The refill reservoir 140 includes an outlet orifice or opening 144 by which the aerosol generating material 142 can pass out of the refill reservoir 140.

A second port 156 is shaped and dimensioned to receive and interface with an article 130. The second or article port 156 is configured to enable an interface between the article 130 and the dock 150, so might alternatively be termed an article interface. Primarily, the article interface is for receiving aerosol-generating material into the article 130, but in some cases the interface may enable additional functions, such as electrical contacts and sensing capabilities for communication between the article 130 and the dock 150 and determining characteristics and features of the reservoir 130.

The article 130 itself comprises a wall or housing 131 that has within it (but possibly not occupying all the space within the wall 131) a storage area 103 for holding aerosol-generating material. The volume of the storage area 103 is many or several times smaller than the volume of the refill reservoir 140, so that the article 130 can be refilled multiple times from a single refill reservoir 140. The article 130 also includes an inlet orifice or opening 132 by which aerosol-generating material can enter the storage area 103. Various other elements may be included with the article 130, as discussed above with regard to FIG. 9.

The housing also accommodates a fluid conduit 158, being a passage or flow path by which the reservoir 140 and the storage area 103 of the article 130 are placed in fluid communication, so that aerosol-generating material can move from the refill reservoir 140 to the article 130 when both the refill reservoir 140 and the article 130 are correctly positioned in the dock 150. Placement of the refill reservoir 140 and the article 130 into the dock 150 locates and engages them such that the fluid conduit 158 is connected between the outlet orifice 144 of the reservoir 140 and the inlet orifice 132 of the article 130. Note that in some examples, all or part of the fluid conduit 158 may be formed by parts of the refill reservoir 140 and the article 130, so that the fluid conduit is created and defined only when the refill reservoir 140 and/or the article 130 are placed in the dock 150. In other cases, the fluid conduit 158 may be a flow path defined within the housing 152 of the dock 150, to each end of which the respective orifices are engaged.

Access to the reservoir port 154 and the article port 156 can be by any convenient means. Apertures may be provided in the housing 152 of the dock 150, through which the refill reservoir 140 and the article 130 can be placed or pushed. The refill reservoir 140 and/or the article 130 may be completely contained within the respective apertures or may partially be contained such that a portion of the refill reservoir 140 and/or the article 130 protrude from the respective ports 154, 156. In some instances, doors or the like may be included to cover the apertures to prevent dust or other contaminants from entering the apertures. When the refill reservoir 140 and/or the article 130 are completely contained in the ports 154, 165, the doors or the like might require to be placed in a closed state to allow refilling to take place. Doors, hatches and other hinged coverings, or sliding access elements such as drawers or trays, might include shaped tracks, slots or recesses to receive and hold the refill reservoir 140 or the article 130, which bring the refill reservoir 140 or the article 130 into proper alignment inside the housing 152 when the door, etc. is closed. Alternatively, the housing of the dock 150 may be shaped so as to include recessed portions into which the article 130 or refill reservoir 140 may be inserted. These and other alternatives will be apparent to the skilled person, and do not affect the scope of the present disclosure.

The dock 150 also includes an aerosol generating material transfer mechanism, arrangement, or apparatus 153, operable to move or cause the movement of fluid out of the refill reservoir 140, along the conduit 158 and into the article 130. Various options are contemplated for the transfer mechanism 153, but by way of an example, the transfer mechanism 153 may comprise a fluid pump, such as a peristaltic pump.

A controller 155 is also included in the dock 150, which is operable to control components of the dock 150, in particular to generate and send control signals to operate the transfer mechanism 153. As noted, this may be in response to a user input, such as actuation of a button or switch (not shown) on the housing 152, or automatically in response to both the refill reservoir 140 and the article 130 being detected as present inside their respective ports 154, 156. The controller 155 may therefore be in communication with contacts and/or sensors (not shown) at the ports 154, 156 in order to obtain data from the ports and/or the refill reservoir 140 and article 130 that can be used in the generation of control signals for operating the transfer mechanism 153. The controller 155 may comprise a microcontroller, a microprocessor, or any configuration of circuitry, hardware, firmware or software as preferred; various options will be apparent to the skilled person.

Finally, the dock 150 includes a power source 157 to provide electrical power for the controller 153, and any other electrical components that may be included in the dock, such as sensors, user inputs such as switches, buttons or touch panels, and, if present, display elements such as light emitting diodes and/or display screens to convey information about the dock's operation and status to the user. In addition, the transfer mechanism may be electrically powered. Since the dock 150 may be for permanent location in a house or office, the power source 157 may comprise a socket for connection of an electrical mains cable to the dock 150, so that the dock 150 may be “plugged in” to mains electricity. Any suitable electrical converter to convert mains electricity to a suitable operational supply of electricity to the dock 150 may be provided, either on the mains cable or within the dock 50. Alternatively, the power source 157 may comprise one or more batteries, which might be replaceable or rechargeable, and in the latter case the dock 150 may also comprise a socket connection for a charging cable adapted to recharge the battery or batteries while housed in the dock.

Further details relating to the control of the refilling will now be described. As noted above, the fluid conduit may be wholly or partly formed by parts of the reservoir 140 and the article 130. In particular, an example arrangement for the fluid conduit 158 is a nozzle by which fluid aerosol generating material is dispensed from the refill reservoir 140. The nozzle may be provided as an element of the dock 150, such that the outlet orifice of the refill reservoir 140 is coupled to a first end of the nozzle when the refill reservoir 140 is installed in the dock. Alternatively, the nozzle may be embodied as an integral part of the refill reservoir 140, to provide the outlet orifice. This associates the nozzle only with the particular reservoir and its contents, thereby avoiding any cross-contamination that may arise from using reservoirs of different aerosol-generating material with the same nozzle. The nozzle is engaged into the inlet orifice of the article 130 in order to enable fluid transfer from the reservoir into the article. The engagement may be achieved by movement of the article towards the refill reservoir, or vice versa, for example, when both have been installed in the dock.

FIG. 11 shows a schematic representation of an article arranged for refilling from a reservoir, where both the reservoir and the article are received in appropriate interfaces in a refilling dock (not shown). A refill reservoir 140 containing a source liquid 142 has a nozzle 160 arranged as its outlet orifice, a first end or proximal end 161 of the nozzle 160 being adjacent the refill reservoir 140. The nozzle may be integrally formed with the refill reservoir 140 by molding of a plastics material or 3D printing, for example. This ensures a leak-free juncture between the nozzle 160 and the housing 141 of the refill reservoir 140. Alternatively, the two parts may be formed separately and joined together afterwards, such as by welding, adhesive, a screw-thread or push-fit coupling, or other approach. The nozzle 160 has a tubular elongate shape, and extends from the first end 161 to a second or distal end 162, remote from the refill reservoir 140, which acts as the fluid dispensing point. Fluid is retained in the reservoir by, for example a valve (not shown) at or near the proximal end 161, which is opened when fluid transfer to the article 130 commences. In other cases, surface tension may be sufficient to retain the fluid, for example if the bore of the nozzle 160 is sufficiently small. The distal end 162 is inserted into or otherwise engages with the inlet orifice 132 of the article 130, and in this example extends directly into the storage area 103 of the article 130. In other examples, there may be tubing, pipework or some other fluid flow path connecting the inlet orifice 132 to the interior of the storage area 103. In use, source liquid 142 is moved out of the refill reservoir 140 using the fluid transfer mechanism 153 of the dock 150, along a fluid channel defined by the nozzle 160 (acting as the fluid conduit) from the proximal end 161 to the distal end 162, where it reaches a fluid outlet of the nozzle and flows into the storage area 103, in order to refill the article 130 with liquid aerosol-generating material.

FIG. 11 shows an example arrangement only, and the outlet orifice of the refill reservoir may be configured other than as a nozzle, and as noted, the fluid conduit that allows refilling of the article using the refilling dock may or may not comprise parts of the reservoir and the article. In general, however, the inlet orifice of the article is configured for engagement with the fluid conduit so that fluid from the reservoir can be ejected from the fluid conduit and into the storage area of the article. Engagement with the fluid conduit may be achieved by relative movement between the article and the end of the fluid conduit (such as the distal end of a nozzle) once the article has been inserted into the article port of the refilling dock.

Accordingly, the refilling device/dock 150 is configured to supply aerosol-generating material (source liquid 142) from the refill reservoir 140 to the reservoir 103 of the article 130 in order to refill or replenish the reservoir 103 of the article 130. As noted above, the refilling process is governed by the controller 155 of the refilling device 150, and includes the generation and sending of control signals to the transfer mechanism 153 to cause it to start the movement of aerosol-generating material (source liquid) from the refill reservoir 140 into the article 130. The dock/refilling device may include a mechanism (hereby denoted generally as an aerosol-generating material amount sensing circuitry) configured to detect the amount of aerosol-generating material (source liquid) within the article. The refilling device/dock 150 uses the detected amount of aerosol-generating material (source liquid) within the article 130 to refill the article 130 accordingly.

However, accurate refilling of the article 130 is desired in order to prevent overfilling or underfilling of the article 130, with the former potentially increasing the pressure in the reservoir/storage area, increasing the chance of leaks and spills, and the latter leading to the article becoming empty again more quickly, requiring more frequent refilling actions to be undertaken thus leading to a poor user experience. Thus, in accordance with the present disclosure, the refilling device is configured to accurately refill the article by obtaining a reference value (or values) from the article, where the reference value is used in the process for accurately determining the amount of aerosol-generating material in the article and subsequently controlling the refilling process accordingly.

FIG. 12 schematically shows a section of the dock 150 centered around the article port 156. The dock 150 in FIG. 12 is based on the dock shown in FIG. 10 with like components being labelled with similar reference signs. Some components are omitted for clarity.

FIG. 12 shows the article 130 positioned in the article port 156 and, in this implementation, the article 130 is completely contained within the article port 156. The article 130 is positioned such that the reservoir 103 is also completely contained within the article port 156 when the article 130 is contained in the article port 156. As before, the article 130 is docked in such a way that aerosol generating material can be transferred to the article 130, e.g., through the inlet orifice 132 as described above.

The dock 150 includes an aerosol-generating material amount sensing circuitry configured to sense an amount of aerosol generating material within the article 130. In FIG. 12 the aerosol-generating material amount sensing circuitry includes a pair of capacitor plates 159 positioned either side of the article port 156. Accordingly, when the article 130 is positioned within the article port 156, the article 130 is located between the pair of capacitor plates 159. In this regard, the capacitance as measured between two capacitor plates is a function, in part, of the material between the capacitor plates (otherwise known as the dielectric). More specifically, the capacitance, C, for a pair of parallel capacitor plates can be expressed, mathematically as, C=ε(A/d), where A is the overlapping area of the plates of the capacitors, d is the distance between the capacitor plates and ε the permittivity of the dielectric between the capacitor plates. As the material changes between the capacitor plates 159 of the article port 156, e.g., as a function of the amount of source liquid in the reservoir 103 of the article 103, so too does the measured capacitance. When the reservoir 103 is empty of aerosol-generating material, a value of capacitance for the capacitor plates 159 exists, depending in part of the dielectric value ε of the air occupying the empty reservoir 103. When the reservoir is filled with aerosol-generating material, the space between the capacitor plates 159 is occupied with the aerosol-generating material, which has a different dielectric constant from air. Hence, the capacitance as measured by the capacitance plates is different for a full storage area and an empty storage area, and in fact, any amount of aerosol-generating material in between empty and full. On the assumption that the overlapping area A of the capacitor plates 159 and the distance d between the capacitor plates 159 does not change for a given dock 150, the capacitance as measured between the capacitor plates 159 acts as an indication of the amount of aerosol generating material/source liquid within the article 130.

As seen in FIG. 12, the capacitor plates 159 are coupled, via suitable wiring, to the controller 155. The controller 155 is configured to cause application of an oscillating voltage across the pair of capacitor plates 159 which produces a current flow through the capacitor plates, which in turn can be detected by the controller 155 in a suitable and known manner. The controller 155 can determine, from the corresponding measurement, an indication of the amount of aerosol generating material within the article 130, accordingly, e.g., by using a suitable look-up table or a calibration curve to convert the corresponding measurement into an indication of the amount of aerosol-generating material.

In FIG. 12, the capacitor plates 159 are shown extending approximately the height of the reservoir 103 such that the entire height of the reservoir 103 when the article 130 is engaged with the article port 156 is located between the capacitor plates 159. However, in other implementations, the capacitor plates 159 may extend to different heights, e.g., less than the height of the reservoir 103. However, ensuring that the capacitor plates extend at least the height of the reservoir 103 enables the dock 150 to determine when the article 130 is empty and/or full. In other implementations, a plurality of pairs of capacitor plates may be provided in the dock 150, whereby each pair of capacitor plates is positioned at a different height along the height of the article port 156. In such implementations, each pair of capacitors may act as a level detector transitioning from a capacitance value when air is present between the pair of capacitor plates and a capacitance value when source liquid is present between the capacitor plates. Other arrangements of the capacitator plates may also be contemplated within the principles of the present disclosure.

In accordance with the principles of the present disclosure, the dock 150 (or more specifically the controller 155 thereof) is configured to receive a reference value from the article 130. The reference value is a value that is indicative of a characteristic of the article 130 associated with the aerosol-generating material amount sensing circuitry. More specifically, the reference value indicates a value that is specific to a given article 130 and which can be used by the controller 155 to calibrate/adjust/modify the output from the aerosol-generating material amount sensing circuitry to provide a more accurate reading of the amount of aerosol-generating material within the article 130.

In the example of FIG. 12, the reference value includes or is a capacitance value which is associated with the article 130. As mentioned above, when using the capacitor plates 159 as the aerosol-generating material amount sensing circuitry, the measured capacitance depends in part on the dielectric ε between the capacitor plates. When no article 130 is present in the article port 156, then the dielectric ε between the capacitor plates is the dielectric of air. However, when an article 130 is placed between the capacitor plates 159 (or in other words, the article 130 is located in the article port 156), the dielectric ε is some combination of the dielectric of the various materials that are now located between the capacitor plates 159, which may include the material forming the housing 131 of the article and/or the inlet orifice 132 as well as the material(s) held in the reservoir 103 of the article (which is likely to be some mixture of air and source liquid). The actual dielectric ε may be considered a weighted average of the dielectrics of the various materials positioned between the capacitor plates 159 based on the relative amounts of those materials.

Accordingly, different articles 130 (excluding the contents of the reservoir 103) may have different capacitance values when measured by the aerosol-generating material amount sensing circuitry of the dock 150 based on, for instance, manufacturing tolerances, variations in the purity/composition of the material used for the housing 131 of the article, any manufacturing defects, etc. Therefore, two seemingly identical articles 130 may, in fact, produce quite different capacitance values when measured using the capacitor plates 159 of a given dock 150 (excluding the contents of the reservoir 103).

Hence, in accordance with the present disclosure, the controller 155 receives a reference value from the article 130 which is indicative of the capacitance associated with the article 130 as measured in standard (or rather consistent) conditions, where the reference value is obtained in advance. For example, during manufacture of the article 130, the article 130 may be placed in a testing rig which may comprise a pair of capacitor plates similar to capacitor plates 159. The testing rig may apply a fixed oscillating voltage (that is, a voltage that oscillates between two fixed values) to the capacitor plates of the testing rig and measure the resulting capacitance value. The article 130 may be empty (i.e., completely devoid of any aerosol-generating material) or may have a predefined amount of aerosol-generating material placed within (e.g., 2 ml of source liquid) prior to obtaining the measurement. The measured capacitance value, or a value that is indicative of the measured capacitance (such as a derived dielectric), is recorded and provided to the article 130 as the reference value. When the article 130 is coupled to the dock 150, the controller 155 receives the reference value from the article 130 and uses the reference value to compensate or correct the measured capacitance value obtained using the capacitor plates 159 of the dock.

For instance, mathematically, the measured capacitance obtained by the aerosol-generating material amount sensing circuitry, Cₘ, may be expressed as the capacitance of the article, Cₐ, plus the capacitance of the aerosol-generating material, C_{agm} (or more accurately the capacitance of the aerosol generating material and air in the reservoir 103); that is, Cₘ=Cₐ+C_{agm}.

Assuming in one example, the reference value is the measured capacitance of the empty article 130 obtained in advance (e.g., using the testing rig during manufacture of the article 130), the controller 155 is configured to subtract the reference value Cₐ from the measured capacitance value Cₘ to obtain an indication of the component of the measured capacitance which results from the presence of the aerosol-generating material in the reservoir 103. More generally, the reference value is used to modify the default mapping between the measured capacitance of an arbitrary article and an amount of aerosol-generating material in the arbitrary article (e.g., Cₘ=C_{agm}) based on a value specific to the article 130 (e.g., Cₐ).

In this example, the reference value Cₐ takes into account the empty reservoir 103, such that when there is no aerosol-generating material present in the reservoir 103, the measured capacitance value Cₘ is equal to reference capacitance value Cₐ. The above equation is an example only to illustrate the principles of the present disclosure, and depending on the conditions in which the capacitance of the article 130 is obtained during manufacture, the way in which the controller 155 corrects the measured capacitance may be different from that shown.

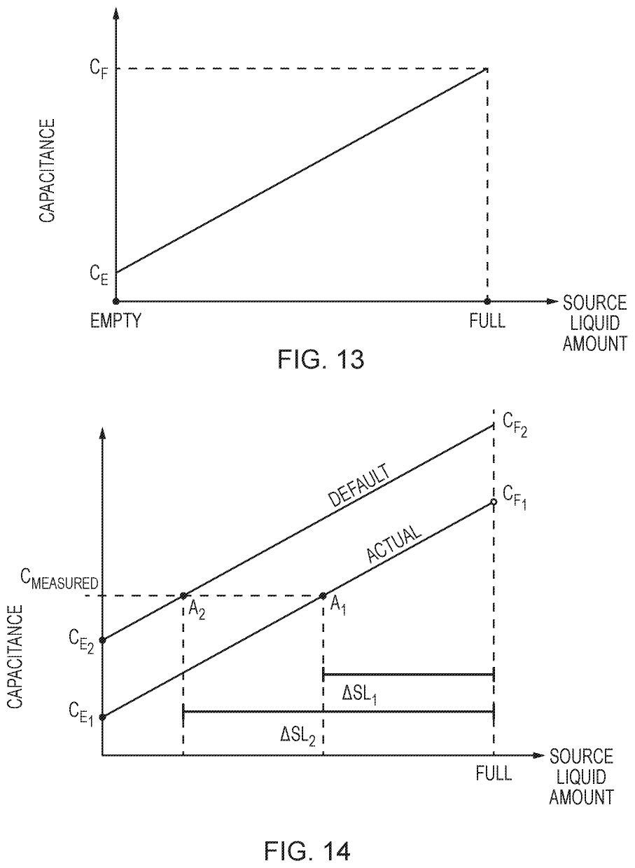

FIG. 13 is a graph indicating a plot of capacitance as measured by the capacitor plates 159 of the dock 150 in arbitrary units (y-axis) versus the amount of source liquid contained in the reservoir 103 of an article 130 in arbitrary units (x-axis). The plot is merely shown as an example of a relationship between measured capacitance and the amount of source liquid and should not be considered as representing a concrete example, but rather is provided to demonstrate aspects of the present disclosure.

In FIG. 13, it is shown that the capacitance varies with the amount of source material in the article 130 from an initial value CE where the article is empty (that is, the reservoir does not contain any source liquid) to a final value CF where the article 130 is full (that is, the reservoir contains the maximum permitted amount of source liquid). In this regard, it should be appreciated that a “full” condition of the article 130 does not necessarily imply that the reservoir 103 is completely filled with source liquid, but may also include situations where a predefined quantity of source liquid, e.g., 2 ml, is within the reservoir 103 of the article. FIG. 13 shows an approximately linear relationship between the measured capacitance value and the amount of source liquid in the reservoir, whereby the capacitance increases with an increasing amount of source liquid. Accordingly, assuming an empty article was coupled to the dock 150, as the dock 150 refills the article 130, the capacitance as measured by the capacitor plates 159 of the dock 150 would increase with increasing source liquid in the reservoir 103.

FIG. 14 is a similar graph to FIG. 13 but shows two plots of capacitance, one starting at the initial value C_{E1} and one starting at the initial value of C_{E2}. The plots are labelled ACTUAL and DEFAULT and are intended to highlight the principles of the present disclosure. The DEFAULT plot shows a variation of capacitance starting from an initial value C_{E2} representing the “empty” article 130 and increasing with the amount of source liquid. The DEFAULT plot may be considered to represent a relationship between measured capacitance and the amount of source liquid in the article 130 in the absence of the reference value described in accordance with the principles of the present disclosure. In other words, a dock 150 which is configured to determine the amount of source liquid in an article 130 simply by measuring the capacitance of the capacitor plates 159 in the presence of an article 130 may employ the relationship as shown by the plot labelled DEFAULT. Dock 150 may be programmed to use this DEFAULT relationship in the absence of any further input. Conversely, the plot labelled ACTUAL may be considered to represent the actual (or accurate) relationship between the measured capacitance and the amount of source liquid in the article 130. Both plots obey the same linear relationship in this example.

FIG. 14 indicates a measured capacitance value, C_{MEASURED}, which represents an example capacitance value that may be obtained by the capacitor plates 159 of dock 150, e.g., in response to an article 130 being coupled to the article port 156 of the dock 150. As shown in FIG. 14, the measured capacitance value, C_{MEASURED}, lies on both the DEFAULT and ACTUAL plots for the capacitance, shown by the points A₁ and A₂. The two points A₁ and A₂ represent different amounts of source liquid in the reservoir 103 of the article 130. In the event that dock 150 is configured to determine the amount of source liquid in the reservoir 103 of the article 130 using the relationship shown by the DEFAULT plot, then it is clear from FIG. 14 that the actual amount of source liquid contained in the reservoir would be underestimated because the amount A₂ is less than the amount A₁.

Accordingly, to provide a more accurate determination of the amount of source liquid contained in the article 130, the article 130 provides the controller 155 with the reference value indicative of a characteristic associated with the capacitance of the article 130. For example, the reference value may be the value C_{E1} which, when obtained by the controller 155, the controller may determine the actual relationship to be used to determine the amount of source liquid in the reservoir 103 (that is, the plot labelled ACTUAL) by using the value C_{E1} as the initial value for the fixed, known linear relationship, or alternatively the reference value may be the difference between the DEFAULT plot and the ACTUAL plot (that is, C_{E2}−C_{E1}), thus allowing the controller 155 to add or subtract the difference to the measured capacitance value to provide an adjusted measured capacitance value. Again, the controller 155 is able to modify a default mapping between the measured capacitance of an arbitrary article and an amount of aerosol-generating material in the arbitrary article using the received reference value to provide a modified mapping that is closer to the actual relationship between the measured capacitance and an amount of aerosol-generating material in the actual article 130.

As shown in FIG. 14, providing a controller 155 for the dock 150 can enable a more accurate refilling of the article 130. For example, if the controller 155 is configured to determine the amount of aerosol-generating material to transfer in order to bring the reservoir 103 of the article to a full state, then on the basis of the modified mapping, the controller 155 is able to calculate this amount of aerosol generating material accurately. FIG. 14 shows that, for the DEFAULT plot, based on the measured capacitance, C_{MEASURED}, the amount of source liquid required to fill the reservoir 103 is ΔSL₂. Conversely, for the ACTUAL plot, based on the measured capacitance, C_{MEASURED}, the amount of source liquid required to fill the reservoir 103 is ΔSL₁, which as can be seen in much less than the amount ΔSL₂. Hence, if the controller 155 is configured to cause the transfer mechanism 153 to deliver the amount of source liquid required to fill the reservoir 103 and to stop the transfer mechanism 153 once the amount of source liquid has been delivered, then the controller 155 would cause the article 130 to overfill if not using the reference value as described in the present disclosure because the amount ΔSL₂ is greater than the actual required amount ΔSL₁. Alternatively, if the controller 155 is configured to determine a capacitance value indicative of the article being full (i.e., an expected capacitance value that when sensed by the capacitor plates 159 of the dock 150 indicates the article 130 is full), then on the basis of the reference value, the controller 155 is able to calculate this amount of aerosol generating material accurately. FIG. 14 shows that, for the DEFAULT plot, based on the measured capacitance, C_{MEASURED}, the expected capacitance value indicative of a full reservoir 103 is C_{F2}. Conversely, for the ACTUAL plot, based on the measured capacitance, C_{MEASURED}, the expected capacitance value indicative of a full reservoir 103 is C_{F1}, which as can be seen in much less than the value C_{F2}. Hence, if the controller 155 is configured to cause the transfer mechanism 153 to stop delivering source once the determined capacitance value has been reached/sensed, then the controller 155 would cause the article 130 to overfill if not using the reference value as described in the present disclosure because the capacitance value C_{F2} would not be reached until after the reservoir is deemed to be full (if the capacitance value C_{F2} can even be reached at all).

Hence, based on the obtained reference value, the controller 155 is able to more accurately determine the amount of aerosol-generating material present in the article 130 using a modified mapping to thereby take into account variances between articles 130 that may otherwise influence the measurement of the amount of aerosol-generating material in the article 130. As a result, the controller 155 is able to more accurately control the refilling process, helping to avoid instances of over- or underfilling of the article 130.

In the above examples, the relationship between capacitance and the amount of source liquid in the reservoir of the article 130 is based on a fixed, linear relationship, which may obey the known formula y=mx+c, where m is the gradient of the straight line and c is a constant corresponding to the intersection of the straight line on the y-axis of the graph. Assuming the gradient of the straight line, m, is fixed and known to the controller 155, then knowing a single reference point on the line is sufficient for the controller 155 to be able to infer any point on that line. In other words, if the gradient m is known and does not vary between articles 130, and c corresponds to the initial “empty” capacitance of the article (e.g., C_{E1} of FIG. 14), then for any measured capacitance C_{MEASURED} (which would take the y parameter in the above equation), the controller 155 is able to calculate the amount of source liquid in the article 130 by solving for the x parameter in the above equation. Accordingly, in such implementations, a single value for the reference value is sufficient for the controller 155 to be able to accurately calculate the amount of aerosol-generating material in the article 130. The gradient of the straight line m may be programmed into the controller 155 or may also be provided by the article 130 when the article is coupled to the dock 150.

However, in some implementations, multiple reference values may be required in order for the controller 155 to be able to accurately calculate the amount of source liquid. In these implementations, not only is the reference value communicated to the article 130, but an indication of the amount of source liquid in the article the reference value corresponds to is also transmitted. For instance, the reference values may be an initial capacitance value CE signifying the capacitance value of the article 130 when the article 130 is empty, and a final capacitance value CF signifying the capacitance value of the article 130 when the article 130 is full.

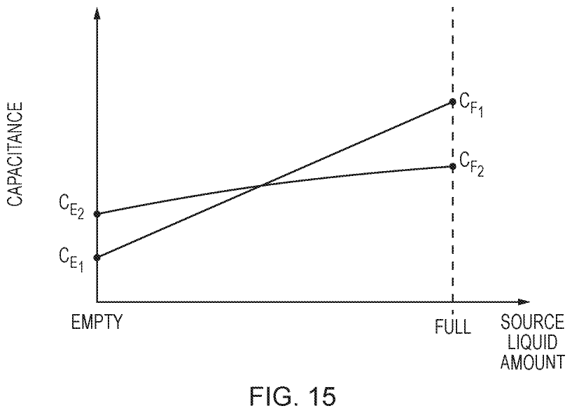

FIG. 15 is a graph showing capacitance versus amount of source liquid in the article in a similar manner to FIG. 14. In FIG. 15, two plots of capacitance, one starting at the initial value C_{E1} and one starting at the initial value of C_{E2}, are shown. The two plots are shown as straight lines having different gradients (that is, different values of m). The line connecting C_{E1} and the capacitance value C_{F1}, which signifies the capacitance as measured when a first article 130 is full, has a steeper gradient than the line connecting C_{E2} and the capacitance value C_{F2}, which signifies the capacitance as measured when a second article 130 is full. In this scenario, to identify which straight line a measured capacitance value corresponds to, the controller 155 obtains at least two reference values from the article 130, e.g., C_{E1} and C_{F1}. This allows the controller 155 to effectively calculate or derive the gradient of the straight line corresponding to the article 130 that is engaged with the dock 150, and thereby allow the controller 155 to correctly identify the source liquid amount in the article 130 from the capacitance value measured by the capacitor plates 159.

Conversely, in other implementations, the reference value may include indications of the parameters to be used in an equation for determining the relationship between measured capacitance and the amount of aerosol generating material. For instance, going back to the example above, whereby the linear relationship contains an unknown gradient m and an unknown intercept c, the reference values may comprise the values m and c and be obtained by the controller 155 from the article 130. In this way, the controller 155 is able to obtain values for the parameters of the relationship corresponding to the specific article 130 to thereby provide a modified mapping of measured capacitance to aerosol generating material amount using the reference values.

It should be appreciated that the relationships shown in FIGS. 13 to 15 between capacitance as sensed by the capacitor plates 159 and the amount of source liquid contained in the reservoir 103 of the article 130 is provided as an example of the relationship to highlight aspects of the present disclosure. In some implementations, the relationship may take a different form, for example a curved line such as a parabolic curve (which may obey the equation y=ax²+bx+c). In these implementations, the controller 155 may obtain a plurality of reference values indicating the measured capacitance for the article 130 at different fill levels (i.e., with different amounts of source liquid therein), where the number of reference values is sufficient for the controller 155 to establish the relationship between capacitance and amount of source liquid, e.g., by extrapolating between the reference values, or obtain values indicative of the parameters a, b and c. Hence, when the controller 155 is provided with a plurality of reference values, the controller 155 is configured to determine the relationship between measured capacitance and the amount of source liquid.

Thus, broadly speaking, the controller 155 of the dock 150 is configured to use the one or more reference values to calculate or establish an actual relationship between the measured capacitance and the amount of source liquid contained in the reservoir 103 of the article 130 by modifying a default mapping between the measured capacitance of an arbitrary article and an amount of aerosol-generating material in the arbitrary article. Either the controller 155 is pre-programmed with the relationship and requires additional data (such as the reference value(s)) to adjust the relationship to the specific article 130 being measured, or the relationship is derivable from the additional data (such as the reference values) provided to the dock 150 from the article 130.

Turning back to FIG. 12, FIG. 12 shows the article 130 provided with a data containing element 130a configured to store the one or more reference values for the article 130. The data containing element 130a of the article 130 may be any suitable data containing element 130a which is at least capable of being read by an associated data reader 156a provided in the dock 150.

The data containing element 130a may be an electronically readable memory (such as a microchip or the like) that contains the reference value(s) for the article 130, for example in the form of a digital/binary code which can be electronically read. The electronically readable memory may be any suitable form of memory, such as electronically erasable programmable read only memory (EEPROM), although other types of suitable memory may be used depending on the application at hand. The electronically readable memory in this implementation is non-volatile, as the article 130 is not continuously coupled to a power source (e.g., the power source 153 located in the dock 150 or the power source 107 located in the device 120). However, in other implementations, the electronically readable memory may be volatile or semi-volatile, in which case the article 130 may require its own power source which may lead to increased costs and increased material wastage when the article 130 is disposed of (e.g., when the article 130 is depleted).

The data containing element 130a may be electronically read by coupling electrical contacts (not shown) on the article 130 with electrical contacts (not shown) in the article port 156. That is, when the article 130 is positioned in the article port 156, an electrical connection is formed between the article 130 and the reader 156a in the article port 156. Application of an electric current from the reader 156a to the data containing element 130a allows the reader 156a to obtain the reference value(s) from the data containing element 130a of the article 130. Alternatively, the data containing element 130a may be electronically read using any suitable wireless technology, such as RFID or NFC, and the article 130 may be provided with suitable hardware (e.g., an antenna) to enable such reading by a suitable wireless reader 156a. The reader 156a is coupled to the controller 155 and is therefore configured to provide the obtained reference value(s) to the controller 155 of the dock 150.

It should be appreciated that the data containing element 130a may be based on other types of suitable data storage mechanisms and, in principle, any element that is able to contain data in a format which can be obtained/read by a suitable reader can be employed in accordance with the present disclosure. For example, the data containing element 130a may comprise an optically readable element containing the reference values (such as a bar code or QR code) and the reader 156a may comprise a suitable optical reader (such as a camera). In this example, the data containing element 130a contains the reference values in the form of images (e.g., arranged bars or pixels). In another example, the data containing element 130a may comprise a magnetically readable element storing the reference values (such as magnetic tags or strips) and the reader 156a may comprise a suitable magnetic reader (such as a magnetic reading head).

It should be appreciated that the type of data containing element 130a is not significant to the principles of the present disclosure and any suitable data containing element which is capable of containing or storing the reference value(s) indicative of a characteristic of the article associated with the aerosol-generating material amount sensing circuitry may be used accordingly. Moreover, although the above provides a data containing element 130a which may be read by an associated reader 156a, it should be appreciated that other ways of storing and communicating the reference value to the controller 155 may be employed in accordance with the principles of the present disclosure. For example, the article 130 may be configured to mechanically engage with the dock 150 in a specific manner such that the engagement signifies the reference value to the dock 150.

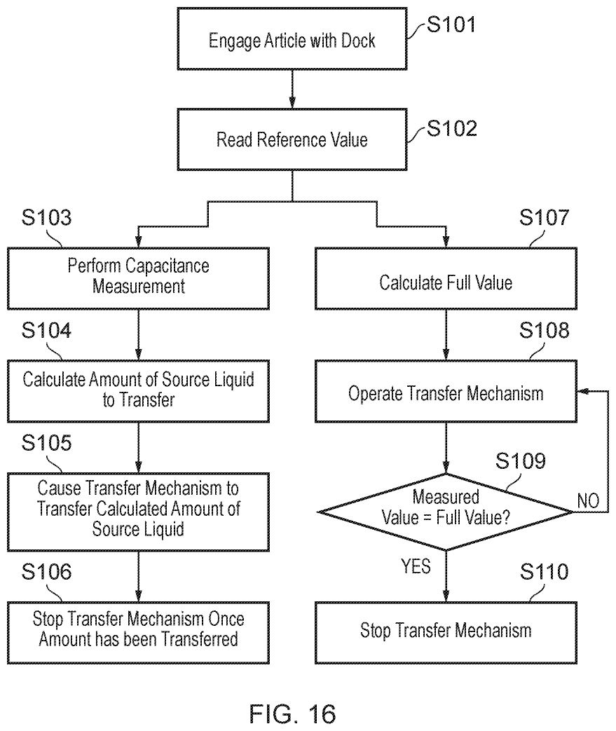

FIG. 16 is a flow diagram indicating an example method for operating the transfer mechanism 153 of the dock 150 based, at least partly, on the received reference value from the article 130.

The method starts at step S101 where the article 130 is coupled to the dock 150. The article 130 may be coupled to the dock 150 as described above. It is assumed that the refill reservoir 140 is also coupled to the dock 150 either before, simultaneously, or after step S101.

At step S102, the controller 155 is configured to read the reference value from the article 130. As described, the article 130 comprises a data containing element 130a which may be read by an associated reader 156a located in the dock 150, such that the controller 155 is able to obtain the reference value(s) from the dock 150 using the reader 156a. Any of the specific technologies for storing and communicating the reference value to the controller 155 may be employed, as described above.

It should be appreciated that in some implementations, refilling of the article 130 may begin automatically once the article 130 and refill reservoir 140 are correctly docked in the dock 150. Thus, before the method can proceed to step S102, the controller 155 may be configured to check the presence of the refill reservoir 140 (and potentially the amount of liquid in the refill reservoir) and only proceed to step S102 once both the article 130 and refill reservoir 140 are docked. In alternative implementations, the refilling may be controlled in response to a user input (i.e. a user request to start the transfer of source liquid using transfer mechanism 153). In these implementations, the controller 155 waits to receive a user input before proceeding to step S102 (and potentially also checks to see whether the article 430 and refill reservoir 140 are docked before allowing the method to proceed to step S102).

After step S102, the method may proceed to either (or both) of step S103 or S107.

Taking step S103 first, at step S103 the controller 155 is configured to cause the capacitor plates 159 (or more broadly, the aerosol-generating material amount sensing circuitry) to take a reading indicative of the amount of source liquid contained in the reservoir 103 of the article 130, or more specifically, a capacitance measurement.

At step S104, the controller 155 is configured to calculate an amount of source liquid to transfer to the reservoir 103 using at least the capacitance measurement obtained at step S103 and the reference value obtained at step S102. For reference, this is the quantity ΔSL shown in FIG. 14. As described above, the controller 155 may have a pre-programmed relationship linking capacitance to an amount of source liquid in the reservoir 103, or the relationship may be derivable from the obtained one or more reference values, or the relationship may be obtained from the article 130 itself (e . . . , from the data containing element 130a). Once the relationship is established, the controller 155 is configured to use the capacitance measurement of step S103 to accurately determine the amount of source liquid in the reservoir 103. Thereafter, the controller is configured to calculate the amount of source liquid to transfer to the reservoir 103 to fill the reservoir 103. This is done by calculating the difference between an amount of liquid that signifies the reservoir is full and the calculated amount of source liquid in the reservoir. The controller 155 may be set to operate to a default fill amount (e.g., 2 ml of source liquid) or the controller 155 may obtain information regarding the size of the reservoir 103 (e.g., from the article 130 itself, such as from the data containing element 130a).

At step S105, the controller 155 causes the transfer mechanism 153 to transfer the amount of source liquid calculated to fill the reservoir 103. The controller 155 and/or the transfer mechanism 153 may be configured to monitor the amount of source liquid transferred by the transfer mechanism 153 (e.g., by using a flow meter situated in the fluid conduit 158 to determine the amount of material transferred). Alternatively, the controller 155 may set the operational parameters of the fluid transfer mechanism 153 to transfer the determined amount of source liquid (e.g., by setting the duration the transfer mechanism 153 is switched on for).

At step S106, once the transfer mechanism 153 has transferred the amount of source liquid to the reservoir 103, the controller 155 causes the transfer mechanism to cease transferring source liquid. The controller 155 may also cause a notification to be provided to the user informing the user that refilling has been completed.

Referring back to step S103, the method may instead of or additionally proceed to step S107. At step S107, on the basis of the reference value obtained at step S102, the controller 155 is configured to calculate a full value which is, in this case, a capacitance value that when measured by the capacitor plates 159 signifies that the article 130 is full with source liquid. More generally, the full value is a value which when measured by the aerosol-generating material amount sensing circuitry signifies the article 130 is full with aerosol-generating material. As discussed in relation to step S104, the controller 155 may have a pre-programmed relationship linking capacitance to an amount of source liquid in the reservoir 103, or the relationship may be derivable from the obtained one or more reference values, or the relationship may be obtained from the article 130 itself (e . . . , from the data containing element 130a). Using the established relationship, in step S107, the controller 155 is configured to calculate the full value based on establishing what the capacitance value would be for a reservoir having a source amount of liquid meeting a predefined fill criteria (as discussed above, this may be a default fill amount (e.g., 2 ml of source liquid) or obtained information regarding the size of the reservoir 103, e.g., from the article 130 itself, such as from the data containing element 130a).

At step S108, the controller 155 is configured to cause the transfer mechanism to transfer source liquid from the refill reservoir 140 to the article 130 in accordance with the techniques above. At step S109, the controller 155 is configured to monitor the capacitance measurement obtained by the capacitor plates 159 and determine when the measured capacitance value is equal to the calculated full value (the capacitance value indicating the reservoir 103 is full with source liquid according to the predefined fill criteria). If the measured capacitance value is not equal to the full value (or more accurately, is less than the full value), i.e., a “NO” at step S109, the method proceeds back to step S108 and the transfer mechanism 153 is operated to continue transferring source liquid to the article 30. Conversely, if the measured capacitance value is equal to the full value (or more accurately, is more than or equal to the full value), i.e., a “YES” at step S109, the method proceeds to step S110 where the controller 155 causes the transfer mechanism to cease transferring source liquid. The controller 155 may also cause a notification to be provided to the user informing the user that refilling has been completed.

As mentioned, the method may proceed according to steps S103 to S106 and/or steps S107 to S110. If the controller 155 is configured to operate according to both S103 to S106 and S107 to S110, then in some implementations, whichever criteria is met first (that is, whether the amount of source liquid required to fill the reservoir is transferred or whether the capacitor plates 159 measure the full value) is used to stop the transfer mechanism 153 transferring source liquid to the reservoir 103. Alternatively, the controller 155 may be configured to stop the flow of source liquid once both criteria are met.

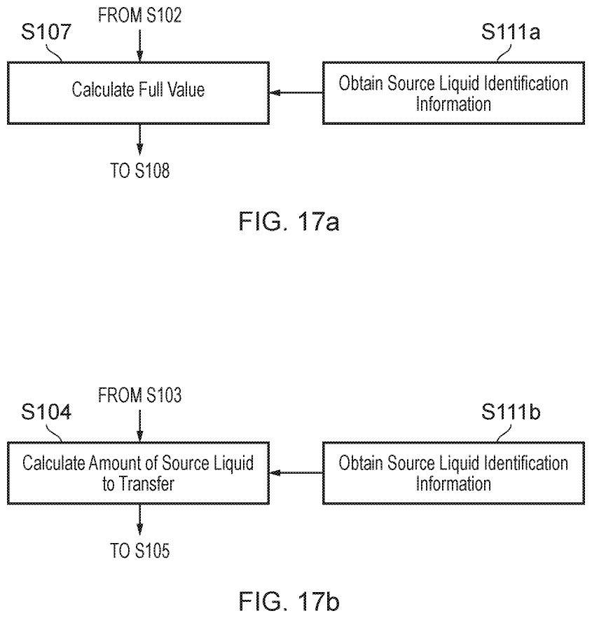

FIGS. 17a and 17b each represent a modification to the method shown in FIG. 16 which may be applied separately or together to the method of FIG. 16. FIG. 17a includes an additional method step S111a which provides information to step S107, while FIG. 17b shows an additional method step S111b which provides information to step S104. Method steps S111a and S111b provide information indicative of the type of source liquid that is contained in the reservoir 103 of the article 130 to the controller 155. For example, the information indicative of the type of source liquid may be contained in the data containing element 130a of the article 130. The information indicative of the type of source liquid specifically relates to information which may have an influence on the capacitance measurement that is performed by the capacitor plates 159. For instance, nicotine can be provided in both an un-protonated and a protonated form, where protonated nicotine contains nicotine salts (formed by inclusion of an proton-donor in the source liquid). The presence of nicotine salts in may lead to a different capacitance measurement being obtained by the capacitor plates 159 at least because salts generally have different electrical properties.

Accordingly, the controller 155 can be configured to obtain an indication of the type of source liquid and use this to help determine the relationship between capacitance and the amount of source liquid for a given article 130. Providing this information may allow the controller 155 to more accurately calculate the amount of aerosol-generating material within the article 130. As discussed above, the article 130 may in some implementations provide the controller 155 with the relationship between capacitance and amount of source liquid in the reservoir 103, and in these implementations the indication of the type of source liquid may be effectively encoded in the provided relationship.

Although it has been described above that the aerosol-generating material amount sensing circuitry is formed of one or more pairs of capacitor plates 159 and associated capacitance measurement circuitry of the controller 155, the aerosol-generating material amount sensing circuitry may comprise any suitable sensing circuitry capable of sensing the amount of aerosol-generating material within the article 130. For example, the aerosol-generating material amount sensing circuitry may comprise a weighing mechanism, such as a scale, configured to sense the weight of the article 130, which is interpreted by the controller 155 to represent the amount of aerosol-generating material within the article 130. Any suitable mechanism may be used in accordance with the principles of the present disclosure.

Equally, the reference value, although described as a capacitance value, may represent any suitable characteristic of the article associated with the aerosol-generating material amount sensing circuitry. For instance, in the above example, the reference value may comprise a weight value. The reference value is therefore a characteristic which is associated with the specific-type of aerosol-generating material amount sensing circuitry and would suitably be identified by the skilled person.

Further, and for the avoidance of doubt, as described above the principles of the present disclosure may be applied to aerosol-generating materials of any type (e.g., solid, liquid, gel, gas, etc.) and any correspondingly suitable transfer mechanism adapted to transfer the aerosol-generating material to the article 130.

It should be appreciated that the methods shown in FIGS. 16, 17a and 17b are provided to explain certain features applicable to the present disclosure. It should be understood by the skilled person that combinations of the features disclosed in the respective methods is permitted within the scope of the disclosure.

Further, while it has generally been described that the default mapping implemented by the controller 155 is based on an equation (defining the relationship between the measured capacitance of an arbitrary article and an amount of aerosol-generating material in the arbitrary article), it should be appreciated that the relationship may be recorded/stored in other ways. For example, the controller 155 may comprise a look-up table storing values of measured capacitances against fill levels for an article. The look-up table may comprise default information (e.g., default values for measured capacitances and fill levels) which are modified as a result of receiving the reference value. For example, the reference value may suggest the same adjustment to each of the values in the look-up table (e.g., a subtraction of an amount) or provide parameters for an equation that can be used to adjust the values of the look-up table, or a plurality of reference values may be provided to provide different adjustments to the values within the table or to provide multiple parameters to an equation. Thus, in principle, the mapping between the measured capacitance of an arbitrary article and an amount of aerosol-generating material in the arbitrary article may take any suitable form. Further, the methods described in FIGS. 16, 17a and 17b illustrate relevant features in the context of the present disclosure. The methods may be modified to include additional steps not directly related to the present disclosure. For example, the article 130 may comprise information related to the lifetime of the source liquid contained within the article 130. In some implementations, the information may be a data of manufacture, a date of sale, a batch number, etc. The controller 155 may obtain the source liquid lifetime information from the article 130 and, in the event that the source liquid lifetime information indicates that the source liquid has expired (e.g., the date of manufacture differs from the current date by greater than a threshold amount), the controller 155 may be configured to prevent refilling of the article 130 from the refill reservoir 140. The source liquid lifetime information may be stored in the data containing element 130a.

Equally, the article 130 may comprise identification information related to the identity of the article 130. In some implementations, the identification information may be a unique identifier uniquely identifying the article 130, a batch number, etc. The controller 155 may obtain the identification information from the article 130 and, in the event that the identification information indicates that the article 130 is unsuitable for use (e.g., because the unique identifier indicates the article 130 is not genuine), the controller 155 may be configured to prevent refilling of the article 130 from the refill reservoir 140. The identification information may be stored in the data containing element 130a.

Although it has been described above that the refilling device/dock 150 is provided to transfer source liquid from a refill reservoir 140 to an article 130, as discussed, other implementations may use other aerosol-generating materials (such as solids, e.g., tobacco). The principles of the present disclosure apply equally to other types of aerosol-generating material, and suitable refill reservoirs 140 and articles 130 for storing/holding the aerosol-generating materials, and a suitable transfer mechanism 153, may accordingly be employed by the skilled person for such implementations.

In addition, although it has been described above that the capacitance of the article is measured and the reference value includes an indication of the capacitance of the article, it should be appreciated that other parameters may be used. Thus, more generally, the aerosol-generating material amount sensing circuitry may sense an indication of a characteristic of the article which may include a measured capacitance as well as other properties that could be sued to determine the amount of aerosol generating material in the article, e.g., the weight of the article.

Hence, it has been described a refilling device for refilling an article with aerosol-generating material for use with an aerosol provision device, the refilling device comprising: a transfer mechanism configured to transfer aerosol-generating material to the article; aerosol-generating material amount sensing circuitry configured to determine an amount of aerosol-generating material within the article when engaged with the refilling device; and a controller configured to: receive a reference value from the article, the reference value indicative of a characteristic of the article associated with the aerosol-generating material amount sensing circuitry; using at least the received reference value to modify a default mapping between the measured indication of a characteristic of an arbitrary article and an amount of aerosol-generating material in the arbitrary article; and control the refilling mechanism to supply an amount of aerosol-generating material to the article based on the modified mapping. Also described is an article, a system, and a method.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An article for an aerosol provision system, comprising:
a storage area for aerosol-generating material;
an inlet orifice in fluid communication with an interior of the storage area by which aerosol-generating material can be added into the storage area;
a first capacitive sensor comprising a first pair of capacitor plates arranged to measure a capacitance of the storage area;
a second capacitive sensor comprising a second pair of capacitor plates arranged to measure a capacitance of the storage area; and
electrical contacts by which capacitance measurements made by the first capacitive sensor and the second capacitive sensor can be separately ascertained externally to the article.

2. An article according to claim 1, wherein the first pair of capacitor plates have a larger area than the second pair of capacitor plates.

3. An article according to claim 1, wherein the first pair of capacitor plates has a first sensor dimension along a direction of increasing fluid level when aerosol-generating material is added into the storage area, the second pair of capacitor plates has a second sensor dimension along the direction of increasing fluid level, and the first sensor dimension is greater than the second sensor dimension.

4. An article according to claim 3, wherein the first sensor dimension extends from a zero fluid level corresponding to the storage area being empty of aerosol-generating material to a maximum fluid level corresponding to the storage area containing its full capacity of aerosol-generating material.

5. An article according to claim 3, wherein the second sensor dimension extends from a zero fluid level corresponding to the storage area being empty of aerosol-generating material to a partial fluid level corresponding to the storage area containing less than its full capacity of aerosol-generating material.

6. An article according to claim 5, wherein the second sensor dimension is not more than 20% of the first sensor dimension.

7. An article according to claim 3, wherein the first pair of capacitor plates has a first sensor width perpendicular to the direction of increasing fluid level, the second pair of capacitor plates has a second sensor width perpendicular to the direction of increasing fluid level, and the first sensor width and the second sensor width are substantially equal.

8. An article according to claim 1, wherein a capacitor plate of the first capacitive sensor or a capacitor plate of the second capacitive sensor comprises a heating element in the article configured to vaporize aerosol-generating material from the storage area.

9. An aerosol provision system comprising an article according to claim 1.

10. A refilling device for refilling an article from a reservoir, comprising:
a reservoir interface for receiving a reservoir containing aerosol-generating material and having an outlet orifice;
an article interface for receiving an article of an aerosol provision system having a storage area for aerosol-generating material, such that a fluid flow path is formed between the outlet orifice of the reservoir and the storage area of the article, the article according to claim 1;
a transfer mechanism operable to move aerosol generating material from a received reservoir to the storage area of a received article; and
a controller configured to operate the transfer mechanism, and also to:
retrieve first capacitance measurements made by the first capacitive sensor and second capacitance measurements made by the second capacitive sensor while the transfer mechanism is operating;
process the first capacitance measurements and the second capacitance measurements to determine when the storage area of the article contains aerosol generating material to a predetermined capacity of the storage area; and
in response, cease operation of the transfer mechanism.

11. A refilling device according to claim 10, wherein the predetermined capacity of the storage area is a maximum capacity of the storage area.

12. A refilling device according claim 10, wherein the controller is configured to process the first capacitance measurements and the second capacitance measurements by applying a correction to the first capacitance measurements which is derived from the second capacitance measurements, and monitoring the corrected first capacitance measurements to identify when a value corresponding to the predetermined capacity of the storage area is reached.

13. A refilling device according to claim 12, wherein the controller is configured to derive a temperature value for aerosol generating material in the storage area from the second capacitance measurements, and to correct the first capacitance measurements according to the derived temperature value.

14. A refilling device according to claim 10, wherein the refilling device is configured to connect each of the first capacitive sensor and the second capacitive sensor to ground when retrieving capacitance measurements from the other of the first capacitive sensor and the second capacitive sensor.

15. A refilling device according to claim 10, wherein the controller is configured to apply a nonlinear relationship between the first capacitance measurements and a level of aerosol-generating material in the storage area when determining that the storage area contains aerosol-generating material to the predetermined capacity.

16. A refilling device according to claim 15, wherein the nonlinear relationship accounts for changes in a cross-sectional configuration of the storage area and the first pair of capacitor plates along a direction of increasing fluid level when aerosol-generating material is added into the storage area.

17. Apparatus for refilling an article of an aerosol provision system, the apparatus comprising an aerosol provision system comprising an article according to claim 1, and a refilling device comprising:
a reservoir interface for receiving a reservoir containing aerosol-generating material and having an outlet orifice;
an article interface for receiving an article of an aerosol provision system having a storage area for aerosol-generating material, such that a fluid flow path is formed between the outlet orifice of the reservoir and the storage area of the article;
a transfer mechanism operable to move aerosol generating material from a received reservoir to the storage area of a received article; and
a controller configured to operate the transfer mechanism, and also to:
retrieve first capacitance measurements made by the first capacitive sensor and second capacitance measurements made by the second capacitive sensor while the transfer mechanism is operating;
process the first capacitance measurements and the second capacitance measurements to determine when the storage area of the article contains aerosol generating material to a predetermined capacity of the storage area; and
in response, cease operation of the transfer mechanism.

18. A method of refilling an article from a reservoir, comprising:
obtaining first capacitance measurements of a storage area of the article from a first capacitive sensor and second capacitance measurements of the storage area of the article from a second capacitive sensor while aerosol-generating material is moved from the reservoir into the storage area;
processing the first capacitance measurements and the second capacitance measurements to determine when the storage area contains aerosol generating material to a predetermined capacity of the storage area; and
ceasing movement of the aerosol-generating material into the storage area when the predetermined capacity is determined to be reached.

19. A method according to claim 18, wherein the predetermined capacity of the storage area is a maximum capacity of the storage area.

20. A method according to claim 18, wherein the first capacitive sensor comprises a first pair of capacitor plates with a first sensor dimension along a direction of increasing fluid level when aerosol-generating material is moved into the storage area, the second capacitive sensor comprises a second pair of capacitor plates with a second sensor dimension along the direction of increasing fluid level, and the first sensor dimension is greater than the second sensor dimension.

21. A method according to claim 20, wherein the first sensor dimension extends from a zero fluid level corresponding to the storage area being empty of aerosol-generating material to a maximum fluid level corresponding to the storage area containing its full capacity of aerosol-generating material, and the second sensor dimension extends from a zero fluid level corresponding to the storage area being empty of aerosol-generating material to a partial fluid level corresponding to the storage area containing less than its full capacity of aerosol-generating material.

22. A method according to claim 18, wherein processing the first capacitance measurements and the second capacitance measurements comprises applying a correction to the first capacitance measurements which is derived from the second capacitance measurements, and monitoring the corrected first capacitance measurements to identify when a value corresponding to the predetermined capacity of the storage area is reached.

23. A method according to claim 22, comprising deriving a temperature value for aerosol generating material in the storage area from the second capacitance measurements, and correcting the first capacitance measurements according to the derived temperature value.

24. A method according to claim 18, comprising applying a nonlinear relationship between the first capacitance measurements and a level of aerosol-generating material in the storage area when determining that the aerosol-generating material reaches the predetermined capacity of the storage area.

25. A method according to claim 24, wherein the nonlinear relationship accounts for changes in a cross-sectional configuration of the storage area and the first pair of capacitor plates along a direction of increasing fluid level when aerosol-generating material is moved into the storage area.

26. A refilling device for refilling an article with aerosol-generating material for use with an aerosol provision device, the refilling device comprising:
a transfer mechanism configured to transfer aerosol-generating material to the article;
aerosol-generating material amount sensing circuitry configured to determine an amount of aerosol-generating material within the article when engaged with the refilling device; and
a controller configured to:
receive a reference value from the article, the reference value indicative of a characteristic of the article associated with the aerosol-generating material amount sensing circuitry;
using at least the received reference value to modify a default mapping between the measured indication of a characteristic of an arbitrary article and an amount of aerosol-generating material in the arbitrary article; and
control the refilling device to supply an amount of aerosol-generating material to the article based on the modified mapping.

27. The refilling device of claim 26, wherein the reference value indicative of a characteristic of the article associated with the aerosol-generating material amount sensing circuitry is determined in advance.

28. The refilling device of claim 26, wherein the reference value indicative of a characteristic of the article associated with the aerosol-generating material amount sensing circuitry comprises a single value, and the controller of the refilling device is configured to control the refilling mechanism to supply an amount of aerosol-generating material to the article based, in part, on the single reference value obtained from the article used to provide the modified mapping.

29. The refilling device of claim 28, wherein the reference value indicates a characteristic of the article associated with the aerosol-generating material amount sensing circuitry when the article contains a predetermined amount of aerosol-generating material.

30. The refilling device of claim 29, wherein the reference value indicates a characteristic of the article associated with the aerosol-generating material amount sensing circuitry when the article is devoid of aerosol-generating material.

31. The refilling device of claim 26, wherein the reference value indicative of a characteristic of the article associated with the aerosol-generating material amount sensing circuitry comprises a plurality of values, and the controller of the refilling device is configured to control the refilling mechanism to supply an amount of aerosol-generating material to the article based, in part, on the plurality of reference values obtained from the article used to provide the modified mapping.

32. The refilling device of claim 31, wherein the plurality of values each indicate a characteristic of the article associated with the aerosol-generating material amount sensing circuitry when the article contains predetermined amounts of aerosol-generating material.

33. The refilling device of claim 32, wherein the plurality of values includes an indication of a characteristic of the article associated with the aerosol-generating material amount sensing circuitry when the article is devoid of aerosol-generating material.

34. The refilling device of claim 31, wherein the plurality of values each indicate a parameter of an equation that defines a relationship between the characteristic of the article associated with the aerosol-generating material amount sensing circuitry and an amount of aerosol-generating material within the article.

35. The refilling device of claim 26, wherein the controller is configured to calculate an amount of aerosol-generating material to transfer to the article based on the output of the aerosol-generating material amount sensing circuitry and the reference value received from the article used to provide the modified mapping.

36. The refilling device of claim 35, wherein the controller is configured to cause the transfer of the amount of aerosol-generating material calculated by the controller using the transfer mechanism, and to cause the transfer of aerosol-generating material to cease once the calculated amount of aerosol-generating material has been transferred.

37. The refilling device of claim 26, wherein the controller is configured to calculate a value to be sensed by the aerosol-generating material amount sensing circuitry indicative of the article being full of aerosol-generating material based on the reference value received from the article used to provide the modified mapping.

38. The refilling device of claim 37, wherein the controller is configured to cease the transfer of aerosol-generating material to the article when the aerosol-generating material amount sensing circuitry outputs the calculated value.

39. The refilling device of claim 26, wherein the aerosol-generating material amount sensing circuitry comprises at least one pair of capacitor plates configured to provide a capacitance value to the controller.

40. The refilling device of claim 39, wherein the at least one pair of capacitor plates are positioned either side of an article port configured to receive the article such that the article is placed between the capacitor plates when engaged with the article port of the refilling device.

41. The refilling device of claim 39, wherein the reference value is a capacitance value obtained in advance by measuring the capacitance of the article under predefined conditions using at least one pair of capacitor plates positioned either side of the article.

42. The refilling device of claim 26, wherein the article comprises a data containing element, the data containing element containing the reference value, and wherein the refilling device comprises a reader configured to read the reference value from the data containing element.

43. An article for use with an aerosol provision device, configured to store aerosol-generating material and to be refilled with aerosol-generating material by a refilling device, the refilling device comprising a transfer mechanism configured to transfer aerosol-generating material to the article and aerosol-generating material amount sensing circuitry configured to determine an amount of aerosol-generating material within the article when engaged with the refilling device, the article comprising:
a reference value, the reference value indicative of a characteristic of the article associated with the aerosol-generating material amount sensing circuitry,
wherein the refilling mechanism is configured to receive the reference value from the article, and using at least the received reference value, modify a default mapping between the measured indication of a characteristic of an arbitrary article and an amount of aerosol-generating material in the arbitrary article, and control the refilling mechanism to supply an amount of aerosol-generating material to the article based on the modified mapping.

44. A system for refilling an article with aerosol-generating material, the system comprising:
the refilling device of claim 26; and
an article configured to store aerosol-generating material and to be refilled with aerosol-generating material by a refilling device, the refilling device comprising a transfer mechanism configured to transfer aerosol-generating material to the article and aerosol-generating material amount sensing circuitry configured to determine an amount of aerosol-generating material within the article when engaged with the refilling device, the article comprising:
a reference value, the reference value indicative of a characteristic of the article associated with the aerosol-generating material amount sensing circuitry,
wherein the refilling mechanism is configured to receive the reference value from the article, and using at least the received reference value, modify a default mapping between the measured indication of a characteristic of an arbitrary article and an amount of aerosol-generating material in the arbitrary article, and control the refilling mechanism to supply an amount of aerosol-generating material to the article based on the modified mapping.

45. A method for operating a refilling device for refilling an article with aerosol-generating material for use with an aerosol provision device, the refilling device comprising a transfer mechanism configured to transfer aerosol-generating material to the article and aerosol-generating material amount sensing circuitry configured to determine an amount of aerosol-generating material within the article when engaged with the refilling device, the method comprising:
receiving a reference value from the article, the reference value indicative of a characteristic of the article associated with the aerosol-generating material amount sensing circuitry;
using at least the received reference value to modify a default mapping between the measured indication of a characteristic of an arbitrary article and an amount of aerosol-generating material in the arbitrary article; and
controlling the refilling device to supply an amount of aerosol-generating material to the article based on the modified mapping.

46. A refilling means for refilling an article with aerosol-generating material for use with aerosol provision means, the refilling means comprising:
transfer means configured to transfer aerosol-generating material to the article;
aerosol-generating material amount sensing means configured to determine an amount of aerosol-generating material within the article when engaged with the refilling means; and
controller means configured to:
receive a reference value from the article, the reference value indicative of a characteristic of the article associated with the aerosol-generating material amount sensing means;
using at least the received reference value to modify a default mapping between the measured indication of a characteristic of an arbitrary article and an amount of aerosol-generating material in the arbitrary article; and
control the refilling means to supply an amount of aerosol-generating material to the article based on the modified mapping.

47. An article for use with aerosol provision means, configured to store aerosol-generating material and to be refilled with aerosol-generating material by refilling means, the refilling means comprising transfer means configured to transfer aerosol-generating material to the article and aerosol-generating material amount sensing means configured to determine an amount of aerosol-generating material within the article when engaged with the refilling means, the article comprising:
a reference value, the reference value indicative of a characteristic of the article associated with the aerosol-generating material amount sensing means,
wherein the refilling means is configured to receive the reference value from the article, and using at least the received reference value, modify a default mapping between the measured indication of a characteristic of an arbitrary article and an amount of aerosol-generating material in the arbitrary article, and control the refilling means to supply an amount of aerosol-generating material to the article based on the modified mapping.
